(19) United States
(12) Patent Application Publication
(10) Pub. No.: US 2018/0054551 A1
(43) Pub. Date: Feb. 22, 2018

(54) OBSERVATION APPARATUS, OBSERVATION METHOD AND OBSERVATION SYSTEM

(71) Applicant: Olympus Corporation, Tokyo (JP)

(72) Inventors: Atsushi TAKAHASHI, Hino-shi (JP); Hiroki AMINO, Hino-shi (JP); Tsuyoshi YAJI, Kawagoe-shi (JP); Osamu NONAKA, Sagamihara-shi (JP)

(21) Appl. No.: 15/679,133

(22) Filed: Aug. 16, 2017

(30) Foreign Application Priority Data
Aug. 17, 2016 (JP) 2016-159972

(51) Int. Cl. H04N 5/222; H04N 5/225; H04N 5/232; H04N 5/247

(52) U.S. Cl. CPC H04N 5/2228; H04N 5/247; H04N 5/23203; H04N 5/2256

(57) ABSTRACT

An observation apparatus includes an imaging unit configured to take an image of an object, a driving mechanism configured to move the imaging unit, a control circuit configured to control an operation of the driving mechanism and an operation of the imaging unit in association with each other, and a position designation unit configured to designate a priority observation position in part of the object. The control circuit moves the imaging unit to the priority observation position on a priority basis when the control circuit controls the operation of the driving mechanism and the operation of the imaging unit in association with each other to observe a predetermined region including the part of the object.

### CROSS-REFERENCE TO RELATED APPLICATION

This application is based upon and claims the benefit of priority from prior Japanese Patent Application No. 2016-159972, filed on Aug. 17, 2016, the entire contents of which are incorporated herein by reference.

### BACKGROUND OF THE INVENTION

### 1. Field of the Invention

The present invention relates to an observation apparatus, an observation method and an observation system.

### 2. Description of the Related Art

An apparatus wherein a culture vessel is statically placed in an incubator and images of cultured cells or the like in the culture vessel are taken, is known in the art. For example, Jpn. Pat. Appln. KOKAI Publication No. 2005-295818 discloses a technique related to an apparatus which takes a number of images while moving a camera (imaging unit) inside an incubator so as to take images of cells existing in a wide range of a culture vessel.

### BRIEF SUMMARY OF THE INVENTION

According to a first aspect of the present invention, there is provided an observation apparatus including an imaging unit configured to take an image of an object, a driving mechanism configured to move the imaging unit, a control circuit configured to control an operation of the driving mechanism and an operation of the imaging unit in association with each other, and a position designation unit configured to designate a priority observation position in part of the object, wherein the control circuit moves the imaging unit to the priority observation position on a priority basis when the control circuit controls the operation of the driving mechanism and the operation of the imaging unit in association with each other to observe a predetermined region including the part of the object.

According to a second aspect of the present invention, there is provided an observation method in which an operation of an imaging unit configured to take an image of an object and an operation of a driving mechanism configured to move the imaging unit are controlled in association with each other, the method including designating a priority observation position in part of the object; and moving the imaging unit to the priority observation position on a priority basis when the operation of the driving mechanism and the operation of the imaging unit are controlled in association with each other to observe a predetermined region including the part of the object.

According to a third aspect of the present invention, there is provided an observation system including the observation apparatus according to the first aspect wherein the apparatus further includes a communication device, and a controller configured to communicate with the observation apparatus through the communication device and control an operation of the observation apparatus.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute apart of the specification, illustrate embodiments of the invention, and together with the general description given above and the detailed description of the embodiments given below, serve to explain the principles of the invention.

FIG. 1 is a schematic perspective view showing an exemplary configuration of an observation system according to a first embodiment of the present invention.

FIG. 2 is a schematic block diagram of the exemplary configuration of the observation system according to the first embodiment.

FIG. 3 is a schematic side view showing an exemplary configuration of a sample and its neighboring portions in an observation apparatus included in the observation system according to the first embodiment.

FIG. 4 is a plan view of a controller that configures the observation system according to the first embodiment, which schematically shows an exemplary configuration of an input/output device of the controller.

FIG. 5A illustrates a first part of a flowchart showing an example of an observation apparatus control process performed by the observation apparatus according to the first embodiment.

FIG. 5B illustrates a second part of the flowchart showing an example of an observation apparatus control process performed by the observation apparatus according to the first embodiment.

FIG. 6 illustrates backlash correction in the movement direction of an imaging unit of the observation apparatus according to the first embodiment.

FIG. 7 illustrates image acquisition in the observation apparatus according to the first embodiment.

FIG. 8 illustrates a movement pattern of the imaging unit in the observation apparatus according to the first embodiment.

FIG. 9 is a schematic diagram showing an exemplary configuration of observation data acquired by the observation system according to the first embodiment.

FIG. 10A illustrates a first part of a flowchart showing an example of a controller control process performed by the controller according to the first embodiment.

FIG. 10B illustrates a second part of the flowchart showing an example of a controller control process performed by the controller according to the first embodiment.

FIG. 11 illustrates an example of an operation of designating an origin when an observation is started using the controller according to the first embodiment.

FIG. 12 is a schematic perspective view showing an exemplary configuration of an observation system according to a second embodiment of the present invention.

FIG. 13 illustrates initial position determination in an observation apparatus according to the second embodiment.

FIG. 14 illustrates auxiliary driving in the observation apparatus according to the second embodiment.

FIG. 15 illustrates response wait type driving in the observation apparatus according to the second embodiment.

FIG. 16A illustrates a state in which a belt is not extended in the observation apparatus according to the second embodiment.

FIG. 16B illustrates a state in which the belt is extended in the observation apparatus according to the second embodiment.

FIG. 17A illustrates images combined when the belt is not extended in the observation apparatus according to the second embodiment.

FIG. 17B illustrates images combined when the belt is extended in the observation apparatus according to the second embodiment.

FIG. 18A illustrates a first part of a flowchart showing an example of an observation apparatus control process performed by the observation apparatus according to the second embodiment.

FIG. 18B illustrates a second part of the flowchart showing an example of an observation apparatus control process performed by the observation apparatus according to the second embodiment.

### DETAILED DESCRIPTION OF THE INVENTION

### First Embodiment

A first embodiment of the present invention will be described with reference to the accompanying drawings. The observation system according to the first embodiment is a system which takes images of a cell and the like, which are being cultured, and which records the taken images.

(Configuration of Observation System)

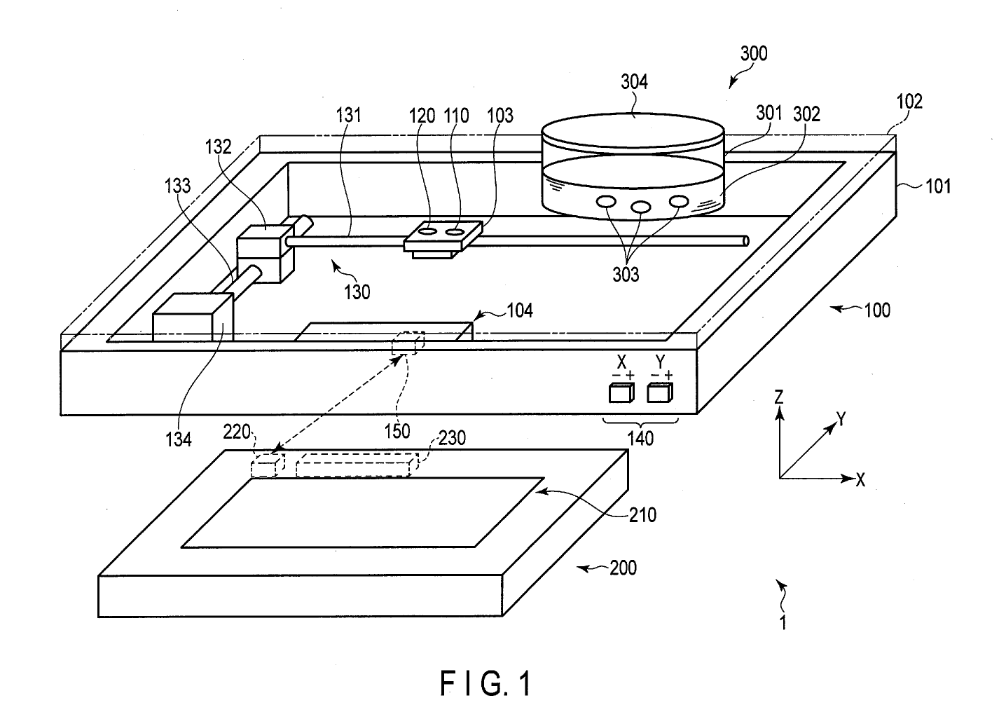

As shown in FIG. 1, the observation system 1 according to the first embodiment includes an observation apparatus 100 and a controller 200.

The observation apparatus 100 includes a casing 101 that is shaped substantially like a plate. The observation apparatus 100 is placed in, for example, an incubator (not shown) or a clean bench (not shown) for operations. On the top of the observation apparatus 100, a sample 300 to be observed is placed. For the sake of description, an X-axis and a Y-axis perpendicular to each other are defined in a plane parallel to the surface of the observation apparatus on which the sample 300 is placed, and a Z-axis is defined as an axis perpendicular to both the X-axis and the Y-axis.

On the top of the casing 101 of the observation apparatus 100, a transparent plate 102 is provided. The sample 300 is mounted on the transparent plate 102. Inside the casing 101 of the observation apparatus 100, an imaging unit 110 is provided. The imaging unit 110 takes an image of the sample 300 through the transparent plate 102 to acquire the image of the sample 300.

The controller 200 is provided outside the incubator. The observation apparatus 100 and the controller 200 communicate with each other wirelessly or by a cable. The controller 200 controls the operation of the observation apparatus 100.

(Sample)

An example of the sample 300 to be observed by the observation system 1 will be described. The sample 300 includes a vessel 301. A culture medium 302 is in the vessel 301, and cells 303 are cultured in the culture medium 302. The vessel 301 is a petri dish, a culture flask, a multiwell plate, or the like. The vessel 301 is a culture vessel for culturing a living specimen, for example. The vessel 301 is not limited to any specific shape, size or the like. The culture medium 302 may be either a liquid medium or a solid medium. The cells 303 to be observed may be either adhesive cells or floating cells. Alternatively, the cells 303 may be spheroids or tissues. In addition, the cells 303 may be derived from any living substance or may be bacteria or the like. As described above, the sample 300 includes a living sample which is either the living substance itself or is derived from the living substance. On the top of the vessel 301, a vessel lid 304 is placed. The vessel lid 304 reflects illumination light, which will be described later.

(Observation Apparatus)

On the top of the casing 101 of the observation apparatus 100, the transparent plate 102 made of, e.g. glass is provided. The sample 300 is statically placed on this transparent plate 102. FIG. 1 shows that the top of the casing 101 is entirely formed of a transparent plate. The observation apparatus 100 may be so configured that part of the top of the casing 101 is a transparent plate and the remaining part thereof is opaque.

Various structural elements of the observation apparatus 100 are provided inside the casing 101. The interior of the incubator has a temperature of 37° C. and a humidity of 95%. Since the observation apparatus 100 is used in the environment of high ambient temperature and humidity, the casing 101 is designed to have an air-tight structure. Although the first embodiment assumes that the observation apparatus 100 is used inside the incubator and emphasizes that it is used mainly to observe cells, the observation apparatus 100 is a generally-used one which is resistant to a severe use environment and which is configured to enlarge details of an object to be observed.

The imaging unit 110 in the casing 101 is fixed and supported on a support member 103. The imaging unit 110 is disposed to take an image of the region where the sample 300 is present and thus acquire a local image of the sample 300.

An illumination unit 120 for illuminating the sample 300 is fixed and supported close to the imaging unit 110 of the support member 103. The illumination unit 120 is disposed to emit illumination light in the direction toward the transparent plate 102, namely, in the direction toward the sample 300.

The support member 103 on which the imaging unit 110 and the illumination unit 120 are fixed is moved by a driving mechanism 130. The driving mechanism 130 includes an X feed screw 131 and an X actuator 132 for moving the support member 103 in the X-axis direction. The driving mechanism 130 also includes a Y feed screw 133 and a Y actuator 134 for moving the support member 103 in the Y-axis direction. In other words, the observation apparatus 100 includes the imaging unit 110 for taking an image of an object such as the sample 300 and the driving mechanism 130 for moving the imaging unit 110. The operations of the driving mechanism 130 and imaging unit 110 are controlled in association with a control unit to be described later. The control unit needs not be one, but a driving control unit and an imaging control unit can be associated with each other in a predetermined sequence. The position of the imaging unit 110 can be controlled while determining an absolute position; however, there are a configuration and a method for controlling the position relatively by the driving amounts of the actuators. In this case, it is important where a reference position or an initial position is set. The observation apparatus 100 according to the first embodiment is so configured that the initial position can be determined using a magnetic sensor, a photocoupler, a specific-position marker or the like, which are not shown. If it is determined how much the actuators are driven, the position of the imaging unit 110 can correctly be adjusted and controlled.

An operation member 140 is provided on the front of the casing 101 to instruct the driving mechanism 130 to move the support member 103 in the X-axis direction and Y-axis direction. The front of the casing 101 is opposed to an incubator opening/closing section for setting the observation apparatus 100 into the incubator. A user can thus operate the operation member 140 through the incubator opening/closing section.

The operation member 140 can be configured as a slide button for providing an instruction to move the imaging unit 110 in the X-axis direction and a slide button for providing an instruction to move it in the Y-axis direction and can also be configured by a cross-direction key or the like. The user can thus move the imaging unit 110 to his or her desired or favorite position as a priority observation position and observe an object intensively and on a priority basis. Since, however, this method allows an observation only in a narrow range, the observation apparatus 100 is configured to take an image of each section in a specific sequence and observe all or part of an observation area corresponding to a movable portion within a specific range. In other words, the observation apparatus 100 includes an observation apparatus control circuit 160 (described later) serving as a control unit to control the driving mechanism 130 and imaging unit 110 in time sequence according to a specific rule in order to observe a predetermined region including at least part of the observation area from the priority observation position.

When the user moves the imaging unit 110 to the priority observation position, the control unit may not be able to understand the relative positional relationship between the priority observation position and the foregoing reference position or initial position due to backlash and play of the driving mechanism 130. In the observation apparatus 100, therefore, a control for removing a backlash is performed in the priority observation position, or an initial positioning is performed to determine a relative position. In this way, the priority observation position is considered to be a driving mechanism driving amount from the initial position, or an error of the drive control position of the driving mechanism 130 can be canceled. The reference position or initial position can be determined by the output of sensors or the like, which are positioned at the drive ends of the imaging unit 110 in the X and Y directions.

If the priority observation position is stored as an actuator driving amount with reference to the initial position, the same region can be monitored repeatedly even after various types of drive control. There is another method for observing a specific region by obtaining a movement error by removing a backlash and a flexure and moving the imaging unit 110 to correct the error. The observation apparatus 100 further includes an observation apparatus storage circuit 170 (described later) as a storage circuit for storing the priority observation position and the movement error. Thus, both the priority observation in a given position and drive association observation in a specific range can be made correctly.

The imaging position in the Z-axis direction is changed by changing the focus position of an imaging optical system of the imaging unit 110. In other words, the imaging optical system includes a focus adjustment mechanism for moving a focusing lens in the direction of the optical axis. In place of the focus adjustment mechanism or in combination therewith, the driving mechanism 130 may include a Z feed screw, a Z actuator, etc. for moving the support member 103 in the Z-axis direction. The moving of the support member 103 in the Z-axis direction may be controlled relatively from the initial position to move to the absolute position by a stepping motor, as in the X-axis and Y-axis directions.

A circuit group 104 for controlling the imaging unit 110, illumination unit 120 and driving mechanism 130 are provided inside the casing 101. The circuit group 104 is provided with an observation apparatus communication device 150. The observation apparatus communication device 150 is, for example, a device which communicates with the controller 200 by wireless. The communications are wireless communications using Wi-Fi (registered trademark), Bluetooth (registered trademark) or the like. The observation apparatus 100 and the controller 200 may be connected by a cable, and cable communications may be performed between them. As described above, the imaging unit 110 (which generates image data by photographing an object through the transparent plate 102) and the driving mechanism 130 (which moves the imaging unit 110) are provided inside the casing 101. This structure increases reliability, facilitates handling and cleaning, and prevents contamination and the like.

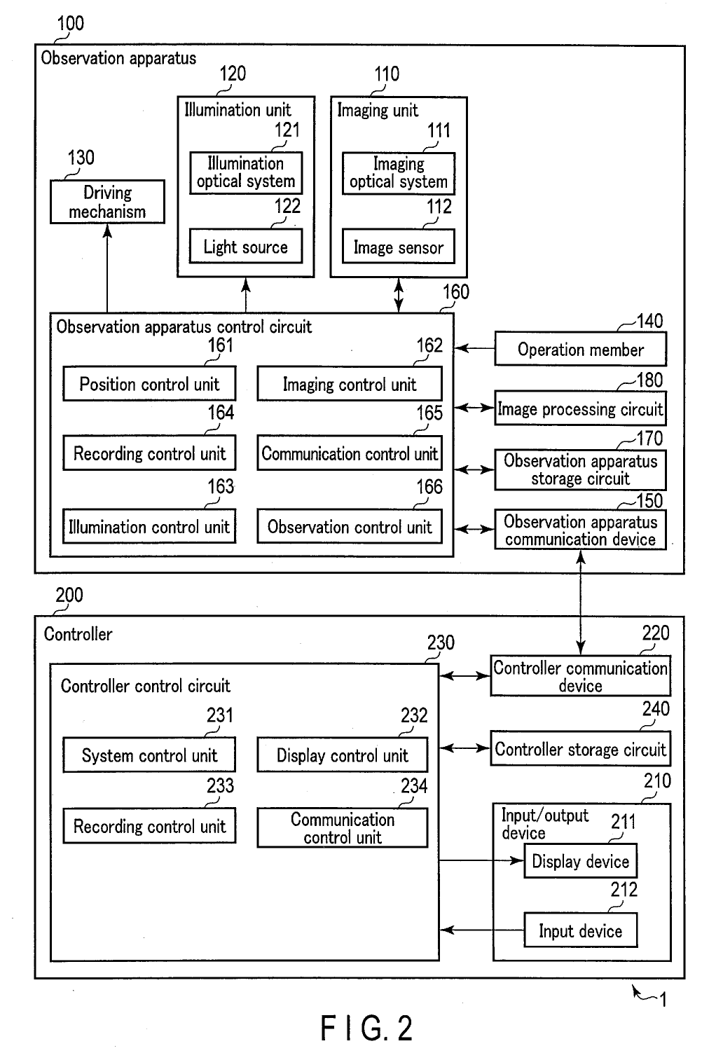

The observation system 1 will be described further in detail with reference to FIG. 2 showing functional blocks of the observation system 1.

The imaging unit 110 includes an imaging optical system 111 and an image sensor 112. The imaging unit 110 generates image data based on an image formed on the imaging plane of the image sensor 112 by the imaging optical system 111.

The illumination unit 120 includes an illumination optical system 121 and a light source 122. The light source 122 emits illumination light. The sample 300 is irradiated with the illumination light through the illumination optical system 121. The light source 122 includes, for example, an LED. Though it has been described that the illumination unit 120 is fixed on the support member 103, a light radiation portion of the illumination optical system 121 has only to be placed on the support member 103 and, for example, the light source 122 can also be placed anywhere in the observation apparatus 100.

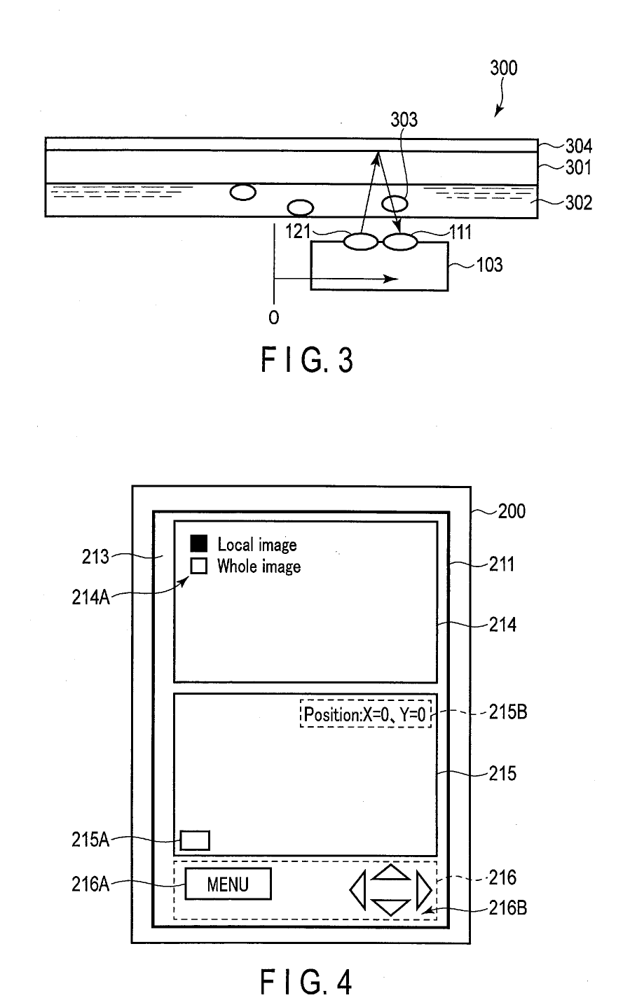

FIG. 3 is a schematic diagram showing the sample 300 viewed from one side thereof. As shown in FIG. 3, the vessel lid 304, which is made of transparent plastics and provided on the top of the vessel 301, is irradiated with the illumination light emitted from the illumination optical system 121 of the illumination unit 120 on the support member 103. The vessel lid 304 transmits part of the illumination light and reflects the other. The vessel lid 304 can thus be designed as a reflector plate. The light reflected by the vessel lid 304 illuminates the cells 303 and enters the imaging optical system 111 of the imaging unit 110. The region illuminated by the illumination light covers at least a local area of the sample 300 which corresponds to one image taken by the imaging unit 110.

As shown in FIG. 2, the observation apparatus 100 includes an observation apparatus control circuit 160, an observation apparatus storage circuit 170 and an image processing circuit 180, in addition to the foregoing imaging unit 110, illumination unit 120, driving mechanism 130, operation member 140 and observation apparatus communication device 150. The observation apparatus communication device 150, observation apparatus control circuit 160, observation apparatus storage circuit 170 and image processing circuit 180 are arranged, for example, in the circuit group 104 described above.

The observation apparatus control circuit 160 controls the operation of each of the elements of the observation apparatus 100. The observation apparatus control circuit 160 includes functions as a position control unit 161, an imaging control unit 162, an illumination control unit 163, a recording control unit 164, a communication control unit 165 and an observation control unit 166.

The position control unit 161 controls the driving mechanism 130 to control the position of the support member 103. The imaging control unit 162 controls the imaging unit 110 to cause the imaging unit 110 to take an image of the sample 300. In other words, the driving mechanism 130 and imaging unit 110 of the observation apparatus 100 are controlled in association with the position control unit 161 and imaging control unit 162 of the observation apparatus control circuit 160.

In this association control, it is important to control a position correctly. This control may be position control to be performed while determining an absolute position and relative control to be performed by the driving amounts of the actuators. It is important which position is a reference position or the initial position. Thus, the initial position can be determined by a magnetic sensor, a photocoupler, a specific-position marker or the like, neither of which is shown. The reference position or the initial position has only to be determined by the output of a sort of sensor, such as a magnetic sensor, a photocoupler, and a specific-position marker, which is provided by positioning at the drive ends of the imaging unit 110 in the X and Y directions. In this case, however, the imaging unit 110 needs to be configured by a member to which the sensor reacts or needs to have a structure to which the sensor reacts. If it is determined how much the actuators are driven from the reference position or the initial position, the position of the imaging unit 110 can correctly be adjusted and controlled. This position adjustment data can be stored in the observation apparatus storage circuit 170.

The illumination control unit 163 controls the operation of the illumination unit 120. The recording control unit 164 controls recording of data obtained by the observation apparatus 100 on the observation apparatus storage circuit 170. The communication control unit 165 controls communications with the controller 200, which are performed through the observation apparatus communication device 150. The observation control unit 166 controls the overall observation, including observation timings and the number of times the observation is made.

The observation apparatus storage circuit 170 includes a storage medium such as a semiconductor memory to store, for example, programs and various parameters used by the observation apparatus control circuit 160. The observation apparatus storage circuit 170 also stores data, etc. obtained by the observation apparatus 100.

The image processing circuit 180 performs various kinds of image processing for the image data obtained by the imaging unit 110. The data processed by the image processing circuit 180 is stored in, e.g. the observation apparatus storage circuit 170 or transmitted to the controller 200 through the observation apparatus communication device 150 as a taken image.

(Controller)

The controller 200 is a personal computer (PC), a tablet type information terminal or the like. In FIG. 1, a tablet type information terminal is depicted.

The controller 200 of the tablet type information terminal is provided with, for example, an input/output device 210 including a display device 211 (e.g., a liquid crystal display) and an input device 212 (e.g., a touch panel). The touch panel can be placed on almost all the display screen of the display device 211. The input device 212 is not limited to the touch panel but may include a switch, a dial, a keyboard, a mouse, etc.

The controller 200 is provided with a controller communication device 220. The controller communication device 220 is a device which communicates with the observation apparatus communication device 150. The observation apparatus 100 and the controller 200 communicate with each other through the observation apparatus communication device 150 and the controller communication device 220.

The controller 200 includes a controller control circuit 230 and a controller storage circuit 240. The controller control circuit 230 controls each of the elements of the controller 200. The controller storage circuit 240 includes a storage medium such as a semiconductor memory to store, for example, programs and various parameters used by the controller control circuit 230. The controller storage circuit 240 also stores data obtained by the observation apparatus 100 and received from the observation apparatus 100. The controller storage circuit 240 may store positioning parameters.

The controller control circuit 230 includes functions as a system control unit 231, a display control unit 232, a recording control unit 233 and a communication control unit 234. The system control unit 231 performs various operations for controlling the observation of the sample 300. The display control unit 232 controls the display device 211. The display control unit 232 causes the display device 211 to display the necessary information and the like. The recording control unit 233 controls the operation of recording information in the controller storage circuit 240. The communication control unit 234 controls the communications with the observation apparatus 100, which are performed through the controller communication device 220.

The display device 211 of the input/output device displays, for example, an observation screen 213 as shown in FIG. 4. The observation screen 213 includes a taken image display section 214, an imaging position display section 215 and an operation button display section 216.

The taken image display section 214 is a region to display image data received from the observation apparatus 100. The display control unit 232 of the controller control circuit 230 displays, in the taken image display section 214, one of the image data that the imaging unit 110 moves to acquire from a plurality of local areas, as a local image. The display control unit 232 can combine a plurality of local images acquired by the imaging unit 110 and display a whole image. The display control unit 232 may display, in the taken image display section 214, an image size index 214A to indicate which of the local image and the whole image is displayed. The display control unit 232 switches the display between the local image and the whole image based on the operation information input through the input device 212 in response to a touch operation of the image size index 214A.

The imaging position display section 215 is a region to display which portion of the observation apparatus 100 corresponds to an image displayed in the taken image display section 214, namely a region to display an imaging position as a map. The display control unit 232 displays a position index 215A in the imaging position display section 215 to indicate which region of the observation apparatus 100 corresponds to an image being displayed in the taken image display section 214. The position index 215A can be described as character information 215B. In the example of FIG. 4, the character information 215B represents the position of the position index 215A by X and Y coordinates. The display control unit 232 switches a local image to be displayed in the taken image display section 214, based on the operation information input through the input device 212 in response to a touch operation of the imaging position display section 215. As will be described later, the touch operation of the imaging position display section 215 allows a priority observation position (origin of start of observation) to be designated.

The operation button display section 216 is a region to display various operation buttons when necessary. The display control unit 232 displays an image of a necessary operation button in the operation button display section 216 according to the situation of an operation controlled by the observation apparatus control circuit 160. The observation apparatus control circuit 160 controls an operation selected and designated by a user, based on the operation information input through the input device 212 in response to a touch operation in a position corresponding to the image of the operation button. In the example of FIG. 4, the operation button display section 216 displays a menu button 216A to display a list of operations that can be selected by the user and a cross-direction button 216B to instruct the driving mechanism 130 to move the support member 103 in the X-axis and Y-axis directions. The cross-direction button 216B corresponds to the operation member 140.

The observation apparatus control circuit 160 and image processing circuit 180 of the observation apparatus 100 and the controller control circuit 230 of the controller 200 each include an integrated circuit, such as a central processing unit (CPU), an application specific integrated circuit (ASIC) and a field programmable gate array (FPGA). Each of the observation apparatus control circuit 160, image processing circuit 180 and controller control circuit 230 can be configured by a single integrated circuit or the like or by the combination of a plurality of integrated circuits. The observation apparatus control circuit 160 and image processing circuit 180 can be configured by a single integrated circuit or the like.

Each of the position control unit 161, imaging control unit 162, illumination control unit 163, recording control unit 164, communication control unit 165 and observation control unit 166 of the observation apparatus control circuit 160 can be configured by a single integrated circuit or the like or by the combination of a plurality of integrated circuits. Two or more of the position control unit 161, imaging control unit 162, illumination control unit 163, recording control unit 164, communication control unit 165 and observation control unit 166 can be configured by a single integrated circuit or the like.

Likewise, each of the system control unit 231, display control unit 232, recording control unit 233 and communication control unit 234 of the controller control circuit 230 can be configured by a single integrated circuit or the like or by the combination of a plurality of integrated circuits. Two or more of the system control unit 231, display control unit 232, recording control unit 233 and communication control unit 234 can be configured by a single integrated circuit or the like.

The operations of these integrated circuits are executed in accordance with, for example, programs stored in the observation apparatus storage circuit 170 or the controller storage circuit 240, or the programs stored in the storage areas of the integrated circuits.

(Operation of Observation System)

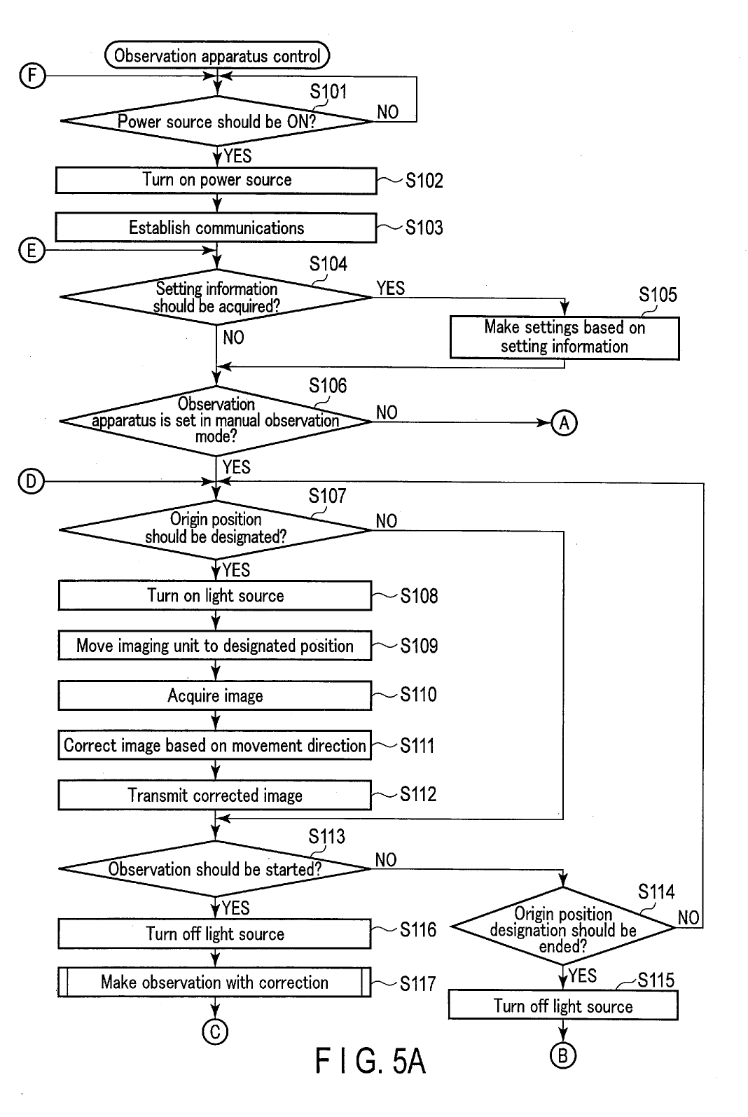

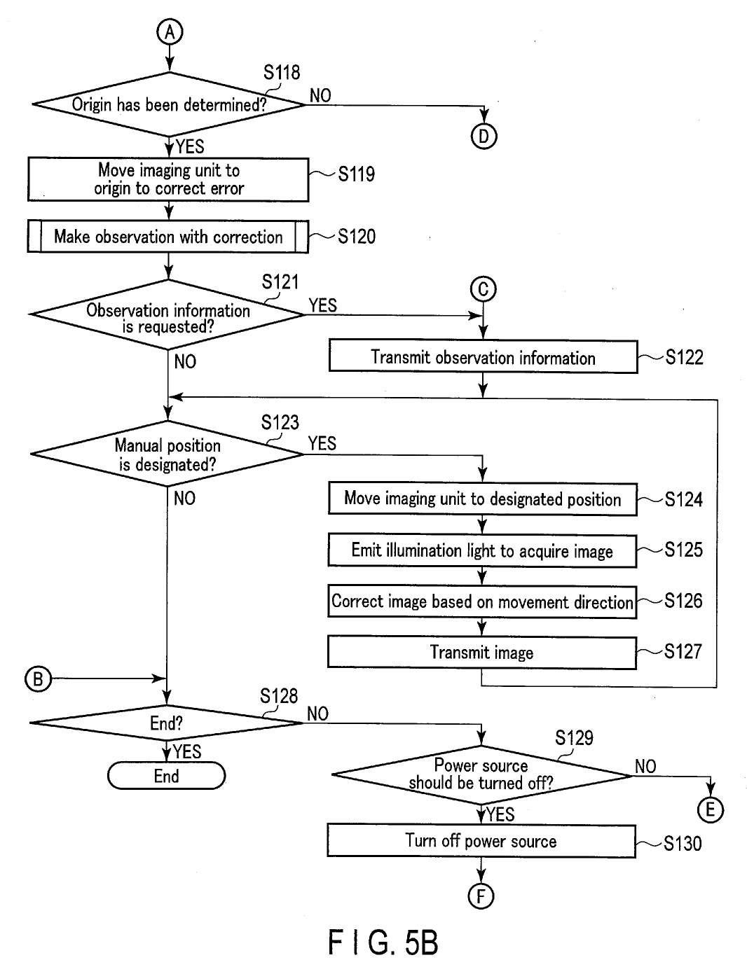

The operation of the observation system 1 will be described. First, the operation of the observation apparatus 100 will be described with reference to the flowchart shown in FIGS. 5A and 5B. The operation of the flowchart starts when the sample 300 is set in the observation apparatus 100 and then the observation apparatus 100 is held in the incubator. The flowchart corresponds to time lapse imaging, such as repeating an observation at predetermined times.

In step S101, the observation apparatus control circuit 160 determines whether the power source should be turned on. The observation apparatus control circuit 160 is configured to turn on the power source, e.g. at predetermined times. The observation apparatus control circuit 160 determines that the power source should be turned on when it is time to turn on the power source. The observation apparatus 100 constantly communicates with the controller 200 through low-power-consumption communication means such as Bluetooth Low Energy. Upon receiving an instruction to turn on the power source from the controller 200 through the communication means, the observation apparatus control circuit 160 may determine that the power source should be turned on. When the observation apparatus control circuit 160 determines that the power source should not be turned on, it repeats the process of step S101 and thus stands by. When the observation apparatus control circuit 160 determines that the power source should be turned on, it advances the process to step S102.

In step S102, the observation apparatus control circuit 160 turns on the power source to supply power to the respective portions of the observation apparatus 100. If the power source is turned on only when necessary, such as when the sample 300 is observed in practice, power saving can be attained. Particularly when the power source of the observation apparatus 100 is a battery, the advantage of lengthening the driving time of the observation apparatus 100 can be obtained.

In step S103, the observation apparatus control circuit 160 establishes communications with the controller 200. The communication means used in this embodiment is high-speed communication means, such as Wi-Fi.

In step S104, the observation apparatus control circuit 160 determines whether setting information should be acquired from the controller 200 through the established communications. For example, when setting information is transmitted from the controller 200, the observation apparatus control circuit 160 determines that the information should be acquired. When it determines that the setting information should not be acquired, it advances the process to step S106. If the observation apparatus control circuit 160 determines that the setting information should be acquired, it advances the process to step S105.

In step S105, the observation apparatus control circuit 160 acquires the setting information transmitted from the controller 200. In accordance with the setting information, the circuit 160 makes settings on the respective portions of the observation apparatus 100 and performs the following process. The acquired setting information includes: information such as observation conditions including a depth of the culture medium 302 of the sample 300, an observation mode, imaging conditions, imaging intervals, information for specifying a movement pattern, and the other parameters; a method for recording observation results; and condition information such as transmission conditions for the observation results. For example, the imaging control unit 162 adjusts the focusing position of the imaging unit 110 using information of a depth of the culture medium 302, namely information of the thickness of an object to be observed. Furthermore, the aperture value, the exposure time, the standby time, the intensity of illumination light, etc. can properly be controlled in accordance with the imaging conditions. After that, the observation apparatus control circuit 160 advances the process to step S106.

The respective portions of the observation apparatus 100 are set in a default state according to default setting information when a first observation is started after the observation apparatus 100 is placed in the incubator. Therefore, when the process advances to step S106 but not through step S105, the observation apparatus control circuit 160 performs a default process for the respective portions set in the default state.

In step S106, the observation apparatus control circuit 160 determines whether the observation apparatus is set in a manual observation mode as the observation mode. The observation mode includes a manual observation mode and an automatic observation mode. In the default state, the observation apparatus 100 is set in the manual observation mode. Since the origin of start of observation is not set when a first observation is started, the setting information transmitted from the controller 200 includes information for setting the observation apparatus 100 in the manual observation mode. It is thus assumed that the observation apparatus 100 is set in the manual observation mode when a first observation is started. When the observation apparatus control circuit 160 determines that the observation apparatus 100 is set in the manual observation mode, it advances the process to step S107. When the circuit 160 determines that the observation apparatus 100 is not set in the manual observation mode, namely when it determines that the observation apparatus 100 is set in the automatic observation mode, it advances the process to step S118.

In step S107, the observation apparatus control circuit 160 determines whether the origin position is manually designated. For example, when the operation member 140 is operated, the observation apparatus control circuit 160 determines that the origin position is manually designated. In other words, the operation member 140 functions as a position designation unit that makes it possible to designate the origin position at which a sample observation is started. Alternatively, when the controller 200 transmits designated position information in response to a user's instruction using the input device 212, such as a touch operation of the cross-direction button 216B of the operation button display section 216 of the display device 211 of the controller 200, the observation apparatus communication device 150 receives the designated position information and the observation apparatus control circuit 160 determines that the origin position is manually designated. In other words, the observation apparatus communication device 150 and observation apparatus control circuit 160 each function as a position designation unit that makes it possible to designate the origin position at which a sample observation is started. When the observation apparatus control circuit 160 determines that the origin position is not manually designated, it advances the process to step S113. When it determines that the origin position is manually designated, it advances the process to step S108.

In step S108, the observation apparatus control circuit 160 turns on the light source 122 of the illumination unit 120 to emit illumination light for observation. When the illumination light has been emitted, the step S108 can be skipped. After that, the observation apparatus control circuit 160 advances the process to step S109. The local area whose image is taken by the imaging unit 110 is considerably smaller than the entire region of the sample 300 as shown in FIG. 4 as the position index 215A, and corresponds to the illumination region of the illumination light. If, therefore, illumination light is emitted in step S108, a user who looks into the incubator to operate the operation member 140, can determine a position in which the illumination light is emitted from the illumination optical system 121 or a position in which the sample 300 is irradiated with the illumination light. From the position, the user can understand the position of the imaging unit 110 disposed close to the illumination unit 120, namely the imaging position. The user can thus operate the operation member 140 or the input device 212 of the controller 200 based on the illumination light emitting position or irradiation position to move the imaging unit 110 to a desired position in which an observation is started, namely a position close to the origin of the observation.

In step S109, the observation apparatus control circuit 160 stores the designated position in the observation apparatus storage circuit 170 as the origin position and operates the driving mechanism 130 to move the imaging unit 110 to the designated position. After that, the observation apparatus control circuit 160 advances the process to step S110.

In step S110, the observation apparatus control circuit 160 causes the imaging unit 110 to acquire an image at the position. After that, the observation apparatus control circuit 160 advances the process to step S111.

In step S111, the observation apparatus control circuit 160 corrects the imaging position information of the acquired image based on the movement direction of the imaging unit 110. In other words, correct imaging position information is added to the acquired image based on the relationship between the last movement direction of the imaging unit 110 and the current movement direction thereof. After that, the observation apparatus control circuit 160 advances the process to step S112.

In step S112, the observation apparatus control circuit 160 transmits the corrected image to the controller 200 through the observation apparatus communication device 150. After that, the observation apparatus control circuit 160 advances the process to step S113.

In step S113, the observation apparatus control circuit 160 determines whether an observation start is designated. For example, the observation apparatus control circuit 160 determines that an observation start is designated when an observation information transmission request is transmitted from the controller 200 in response to a user's instruction using the input device 212, such as a touch operation of an operation button displayed on the operation button display section 216 of the display device 211 of the controller 200. When the circuit 160 determines that an observation start is designated, it advances the process to step S116. When the circuit 160 determines that an observation start is not designated, it advances the process to step S114.

In step S114, the observation apparatus control circuit 160 determines whether the origin position designation is ended. For example, the observation apparatus control circuit 160 determines that the origin position designation is ended when the operation member 140 is operated. The observation apparatus control circuit 160 also determines that the origin position designation is ended when origin position designation end information is transmitted from the controller 200 in response to a user's instruction using the input device 212, such as a touch operation of an operation button displayed on the operation button display section 216 of the display device 211 of the controller 200. When the circuit 160 determines that the origin position designation is not ended, it returns the process to step S107. When the circuit 160 determines that the origin position designation is ended, it advances the process to step S115.

In step S115, the observation apparatus control circuit 160 turns off the light source 122 of the illumination unit 120 to stop emitting illumination light for observation. After that, the observation apparatus control circuit 160 advances the process to step S128. When the illumination light is not emitted, the step S115 can be skipped.

If, therefore, the process from step S107 to step S114 is repeated, a user can determine a desired position at which an observation is started, namely the origin of observation to move the imaging unit 110 to the origin of observation. In other words, the image transmitted in step S112 is displayed on the taken image display section 214 of the display device 211 of the controller 200, and the imaging position based on the imaging position information added to the image is displayed on the imaging position display section 215 of the display device 211 as the position index 215A. The user can thus confirm the display of the observation screen 213 of the display device 211 of the controller 200 in addition to the illumination light emitting position or irradiation position to touch the operation member 140 or the cross-direction button 216B displayed on the display device 211 and move the imaging unit 110 to a desired position at which an observation is started, namely the origin of observation. Accordingly, the user can observe his or her favorite position (a priority observation position or the origin of observation) intensively and by priority. Since, however, this method allows an observation only in a narrow range, the observation apparatus 100 is configured to take images of respective parts in a specific sequence and observe all or part of an observation area corresponding to a movable portion within a specific range. In other words, the observation apparatus control circuit 160 (position control unit 161 and imaging control unit 162) is provided as a control unit and controls the operations of the driving mechanism 130 and imaging unit 110 in time sequence according to a specific rule to observe a predetermined region including at least part of the observation area from the priority observation position.

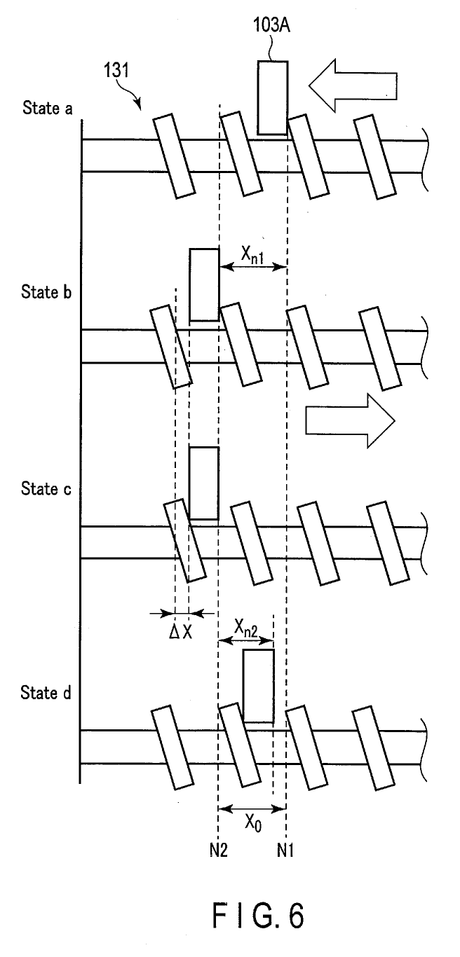

The X feed screw 131 and Y feed screw 133 of the driving mechanism 130 each have a backlash. For example, as shown in FIG. 6, there is a gap between the thread of the X feed screw 131 and the projecting portion 103A of the support member 103 fitted to the X feed screw 131. With this gap, the rotation directions of the feed screw, namely the last and current movement directions of the imaging unit 110 will differ from each other and thus the movement amount of the imaging unit 110 will differ from the rotation amount of the feed screw.

Assume that the projecting portion 103A of the support member 103 abuts on the thread of the X feed screw 131 on the left side of FIG. 6 when the X feed screw 131 rotates by amount N1 as shown as state a in FIG. 6. Assume that from this state a, the X feed screw 131 is rotated by amount N2 corresponding to the movement amount X₀ of the imaging unit 110 in the left direction as indicated by the arrow in FIG. 6. The projecting portion 103A is thus pushed and moved immediately by the thread to move the imaging unit 110 by Xₙ₁ as shown as state b. In this case, Xₙ₁ is equal to X₀.

Assume that from the state b shown in FIG. 6, the X feed screw 131 is rotated by amount N1 corresponding to the movement amount X₀ of the imaging unit 110 in the right direction as indicated by the arrow in FIG. 6. In this state b, the projecting portion 103A does not abut on the thread on the left side in FIG. 6. Therefore, even though the X feed screw 131 is rotated, the imaging unit 110 does not move at once. As shown as state c in FIG. 6, the imaging unit 110 starts to move after the X feed screw 131 rotates by the amount corresponding to gap Δx between the thread on the left side of FIG. 6 and the projecting portion 103A. Consequently, the imaging unit 110 moves by Xₙ₂ only as shown as state d in FIG. 6. In this case, Xₙ₂ is not equal to X₀ but to X₀−Δx. In other words, it can be said that Δx is a movement error caused when the imaging unit 110 moves.

The same as above is true of the reversal of the Y feed screw 133, namely the Y-direction movement amount of the imaging unit 110.

The imaging unit 110 is moved to the origin of observation by repeating the process from step S107 to step S114. If the movement direction of the imaging unit 110 is reversed, it is necessary to consider the influence of a backlash, namely the movement error Δx. In step S111, the imaging position information of the acquired image is corrected based on the movement direction and, in other words, correct imaging position information is added to the acquired image. The origin of observation can thus be designated correctly. When the user moves the imaging unit 110 to the priority observation position, the observation apparatus control circuit 160 may not be able to hold the correct relative positional relationship between the priority observation position and the foregoing reference position or initial position due to backlash and play of the driving mechanism 130. This drawback can be overcome if the control for removing the backlash is performed in the priority observation position. At that time, if a taken image is recorded and the backlash removal control is performed, and then a position in which the same image is acquired in no-backlash state can be found, it will be the virtual “origin.”

The priority observation position may be considered to be a driving mechanism driving amount from the initial position, or an error of the drive control position of the driving mechanism 130 can be canceled, by determining a relative position by initial positioning. For example, the image detected in the priority observation position designated by the user is provisionally recorded. Once the imaging unit 110 is returned to the initial position or the reference position and then the position of an image similar to the provisionally-recorded image, the amount of relative movement of the imaging unit 110 will be position control information. If the position control information is recorded, the priority observation position will be the origin of observation. If the priority observation position is so recorded as an actuator driving amount of the initial position reference, the same place can be monitored repeatedly even after various types of drive control. The amount of relative movement of the imaging unit 110 from the initial position or the reference position can be defined as the virtual “origin.”

If the origin of observation is determined as described above, an observation information transmission request is transmitted from the controller 200 and thus the observation apparatus control circuit 160 determines in step S113 that an observation start is designated and advances the process to step S116.

In step S116, the observation apparatus control circuit 160 turns off the light source 122 of the illumination unit 120 to stop emitting illumination light for observation. After that, the observation apparatus control circuit 160 advances the process to step S117.

In step S117, the observation apparatus control circuit 160 performs an observation process with correction. More specifically, the observation apparatus control circuit 160 turns on the light source 122 of the illumination unit 120 to emit illumination light for observation and instructs the imaging unit 110 and the driving mechanism 130 to cause the imaging unit 110 to take images repeatedly while changing the position of the imaging unit 110 according to a specific rule by the driving mechanism 130. In this case, the rotation amount of the X feed screw 131 or the Y feed screw 133, namely the driving amount of the X actuator 132 or the Y actuator 134 to move the imaging unit 110 is controlled to remove the influence of a backlash as described above, namely to correct the movement error Δx. The observation apparatus control circuit 160 performs a predetermined process for the acquired image and stores a result of observation in the observation apparatus storage circuit 170. Upon completion of observation, the observation apparatus control circuit 160 turns off the light source 122 of the illumination unit 120 to stop emitting illumination light for observation. After that, the observation apparatus control circuit 160 advances the process to step S122.

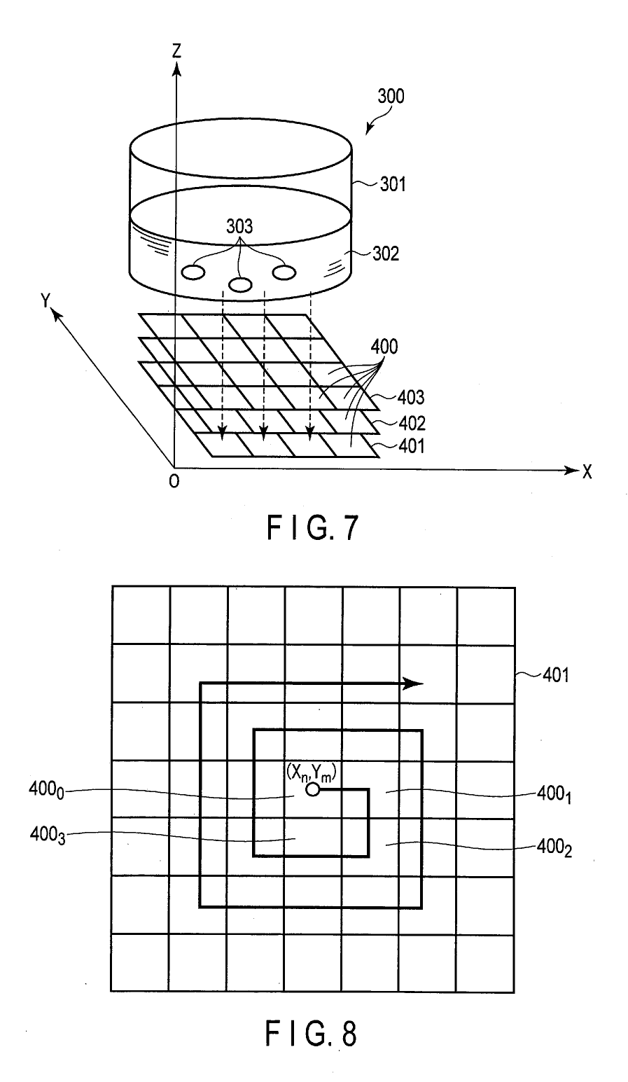

Image acquisition according to the specific rule in the observation process of step S117 will be described with reference to the schematic diagram of FIG. 7. The observation apparatus 100 takes images repeatedly while changing the position in the X direction and Y direction within, e.g. a first plane to acquire a plurality of local images 400 that are locally taken images. The image processing circuit 180 combines the local images 400 into a first whole image 401 that is one taken image in the first plane. The first plane is, for example, perpendicular to the optical axis of the imaging unit 110, namely parallel to the transparent plate 102. The observation apparatus 100 also takes images repeatedly while changing the imaging position to a second plane and then a third plane in the thickness direction and similarly while changing the position in the X direction and Y direction, and combines the images 400 into a second whole image 402 and a third hole image 403. The thickness direction is a Z-axis direction corresponding to the direction of the optical axis of the imaging unit 110 and is perpendicular to the transparent plate 102. Thus, a three-dimensional image of each portion can be acquired.

An example of taking images repeatedly while changing the imaging plane in the Z direction has been described. However, the image taking can be repeated while changing the position only in the X and Y directions without acquiring a plurality of images in the Z direction and, in this case, a combined image of one plane is acquired.

In FIG. 7, the whole images 401, 402 and 403 each include 4×4 local images 400 but actually include more local images 400. The whole images 401, 402 and 403 are not limited to rectangle images. The local images 400 can be acquired such that the whole images are shaped like a polygon to conform to the circular bottom of the vessel 301.

The local images 400 on each plane are acquired by moving the imaging unit 110 in a predetermined movement pattern from the determined origin of observation (Xₙ, Yₘ), as shown in FIG. 8. The predetermined movement pattern follows information for specifying a movement pattern included in the setting information transmitted from the controller 200. Alternatively, it can be preset in the programs stored in the storage area in an integrated circuit to configure the observation apparatus storage circuit 170 and/or the observation apparatus control circuit 160. For the sake of description, FIG. 8 simply shows a movement pattern in 5×5 local images of 7×7 local images 400.

When the imaging unit 110 is moved in accordance with the movement pattern, the influence of a backlash is removed or the movement error Δx is corrected to control the amount of movement so as not to vary with the movement direction of the imaging unit 110. For example, in the example of FIG. 8, the rotation amount of the X feed screw 131 or the driving amount of the X actuator 132 to move the imaging unit 110 from a position in which a local image 400₂ is taken to a position in which a local image 400₃ is taken, is increased by an amount corresponding to the backlash or the movement error Δx more than the rotation amount of the X feed screw 131 or the driving amount of the X actuator 132 to move the imaging unit 110 from a position in which a local image 400₀ is taken to a position in which a local image 400₁ is taken.

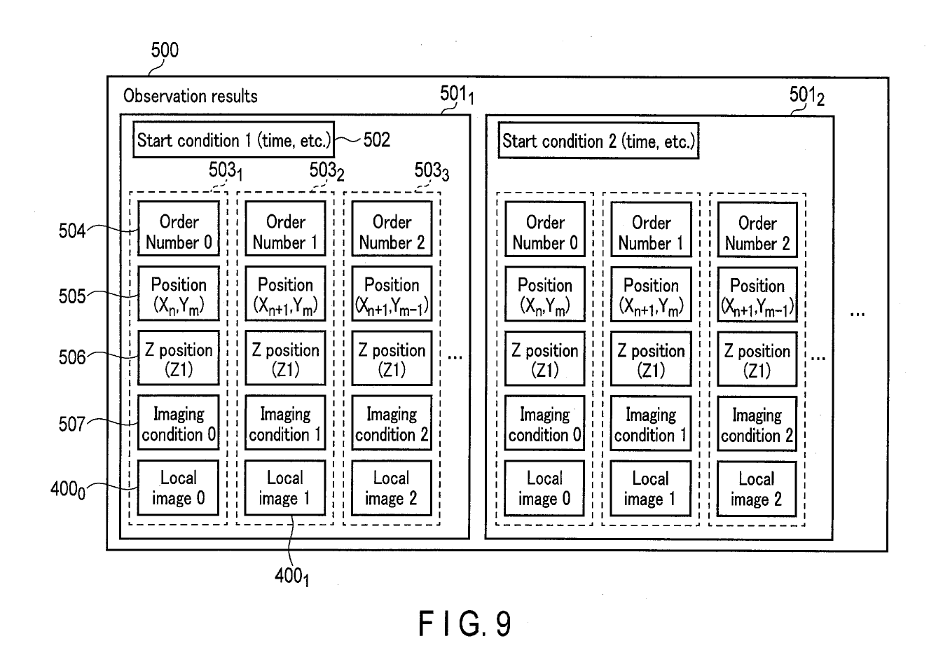

FIG. 9 shows an exemplary configuration of data of observation results acquired as described above and stored in the observation apparatus storage circuit 170. As shown in FIG. 9, observation results 500 include first data 501₁ acquired by a first observation in a manual observation mode. The observation results 500 also include second data 501₂ acquired by a second observation in an automatic observation mode described later. These data increase or decrease in number according to the number of times of observation.

For example, the first data 501₁ includes the following information. In other words, the first data 501₁ includes a start condition 502. In the manual observation mode, the start condition 502 includes time at which an observation starts. In the automatic observation mode, for example, observation start time is determined in advance and thus recorded as the start condition 502.

The first data 501₁ includes first local image information 503₁, second local image information 503₂, third local image information 503₃ and the like. Each information is a set of data acquired when one image is taken.

The first local image information 503₁ includes the following information. In other words, the first local image information 503₁ includes order 504, position 505, Z position 506, imaging condition 507 and local image 400₀. The order 504 is a series number for each imaging when the imaging is repeated while varying the position. The position 505 includes X and Y coordinates of the imaging position. The X and Y coordinates in the first local image information 503₁ are origin coordinates (Xₙ, Yₘ) that were determined. The X and Y coordinates are values used for control of the driving mechanism 130 and can be obtained from, e.g. the position control unit 161. The Z position 506 includes a Z coordinate of the imaging position. The Z coordinate is a value used for control of the imaging optical system 111 and can be obtained from, e.g. the imaging control unit 162. The imaging condition 507 includes exposure conditions such as a shutter speed and an aperture value and the other conditions. The imaging conditions may differ, depending upon each imaging operation. They may be the same for the imaging operations included in the first data 501₁. Alternatively, they may be the same for all imaging operations included in the observation results 500. The local image 400₀ is image data acquired by imaging.

Similarly, the second local image information 503₂ and the third local image information 503₃ each include information of the order, position, Z position, imaging condition and local image. FIG. 9 shows an example of the case of the movement pattern as shown in FIG. 8.

When the imaging plane is not changed in the Z direction, information of the Z position can be omitted.

Like the first data 501₁, the second data 501₂ includes a start condition, first image data, second image data, third image data and the like.

The observation apparatus storage circuit 170 may include all of the observation results 500 as one file and also may include some of the observation results 500 as one file.

Returning to FIGS. 5A and 5B, a description will be continued. When the observation apparatus control circuit 160 determines in step S106 that the observation apparatus is not set in the manual observation mode or it is set in the automatic observation mode, it performs the following process. More specifically, the observation apparatus control circuit 160 determines in step S118 whether the origin of observation has already been determined, namely whether the origin position is stored in the observation apparatus storage circuit 170. When the circuit 160 determines that the origin of observation has not yet been determined, it advances the process to step S107 to determine the origin as in the manual observation mode. When the circuit 160 determines that the origin of observation has been determined, it advances the process to step S119.

In step S119, the observation apparatus control circuit 160 activates the driving mechanism 130 to move the imaging unit 110 to the origin position. The circuit 160 moves the imaging unit 110 to remove the influence of a backlash as described above, namely to correct the movement error Δx. In other words, the circuit 160 controls the rotation amount of the X feed screw 131 or the Y feed screw 133, namely the driving amount of the X actuator 132 or the Y actuator 134 to move the imaging unit 110 to the origin position correctly. After that, the circuit 160 advances the process to step S120.

In step S120, the observation apparatus control circuit 160 performs the same observation process with correction as in step S117. More specifically, the circuit 160 turns on the light source 122 of the illumination unit 120 to emit illumination light for observation and instructs the imaging unit 110 and the driving mechanism 130 to cause the imaging unit 110 to take images repeatedly while changing the position of the imaging unit 110 according to the specific rule by the driving mechanism 130. In this case, the rotation amount of the X feed screw 131 or the Y feed screw 133, namely the driving amount of the X actuator 132 or the Y actuator 134 to move the imaging unit 110 is controlled to remove the influence of the backlash as described above, namely to correct the movement error Δx. The circuit 160 performs the predetermined process for the acquired image and stores a result of observation in the observation apparatus storage circuit 170. Upon completion of observation, the circuit 160 turns off the light source 122 of the illumination unit 120 to stop emitting illumination light for observation. After that, the circuit 160 advances the process to step S121.

In step S121, the observation apparatus control circuit 160 determines whether the controller 200 requests observation information. For example, the controller 200 requests data acquired in the observation with correction in step S120. When the circuit 160 determines that the controller 200 does not request observation information, it advances the process to step S123. When the circuit 160 determines that the controller 200 requests observation information, it advances the process to step S122.

In step S122, the observation apparatus control circuit 160 transmits observation information such as the first data 501₁ and the second data 501₂ acquired by the observation with correction in step S120 or S117 to the controller 200 through the observation apparatus communication device 150. The controller 200 that has received the observation information allows the observation information to be displayed on the display device 211. After that, the circuit 160 advances the process to step S123.

In step S123, the observation apparatus control circuit 160 determines whether a manual position is designated by the controller 200. There is a case where a user confirms the observation information transmitted in step S122 by the display device 211 of the controller 200 and wishes to observe a specific position of the sample 300 again. In this case, a manual position can be designated by a user's instruction using the input device 212, such as an operation of touching a portion corresponding to a specific position of the imaging position display section 215 of the display device 211. When the circuit 160 determines that a manual position is not designated, it advances the process to step S128. When the circuit 160 determines that a manual position is designated, it advances the process to step S124.

In step S124, the observation apparatus control circuit 160 activates the driving mechanism 130 to move the imaging unit 110 to a manually-designated position. After that, the circuit 160 advances the process to step S125.

In step S125, the observation apparatus control circuit 160 causes the illumination unit 120 to emit illumination light and causes the imaging unit 110 to acquire an image in that position. After that, the circuit 160 advances the process to step S126.

In step S126, the observation apparatus control circuit 160 corrects the acquired image based on the movement direction of the imaging unit 110. In other words, correct imaging position information is added to the acquired image based on the relationship between the last movement direction of the imaging unit 110 and the current movement direction thereof, in consideration of the foregoing backlash, namely the movement error Δx. After that, the circuit 160 advances the process to step S127.

In step S127, the observation apparatus control circuit 160 transmits the corrected image to the controller 200 through the observation apparatus communication device 150. After that, the circuit 160 returns the process to step S123.

In step S128, the observation apparatus control circuit 160 determines whether the observation apparatus control process is ended. For example, when the circuit 160 receives an instruction to end the observation apparatus control process from the controller 200, it determines that the observation apparatus control process is ended. When the circuit 160 determines that the observation apparatus control process is ended, it ends the process. For example, in a situation where a series of observations is ended and the observation apparatus 100 is taken out of the incubator, the controller 200 sends an instruction to end the observation apparatus control process and thus the observation apparatus control process is ended. Note that the setting made in step S105 is cleared and a default value is set again, though not shown in particular. When the circuit 160 determines that the observation apparatus control process is not ended, it advances the process to step S129.

In step S129, the observation apparatus control circuit 160 determines whether the power source should be turned off. If standby time from the observation made in step S117 or step S120 to the subsequent observation is long, the circuit 160 determines that the power source should be turned off to save power consumption. Furthermore, when the circuit 160 receives an instruction to turn off the power source from the controller 200, it determines that the power source should be turned off. When the circuit 160 determines that the power source should not be turned off, it returns the process to step S104. When the circuit 160 determines that the power source should be turned off, it advances the process to step S130.

In step S130, the observation apparatus control circuit 160 turns off the power source of each section of the observation apparatus 100. After that, the circuit 160 returns the process to step S101.

The observation apparatus 100 makes an observation repeatedly as described above.

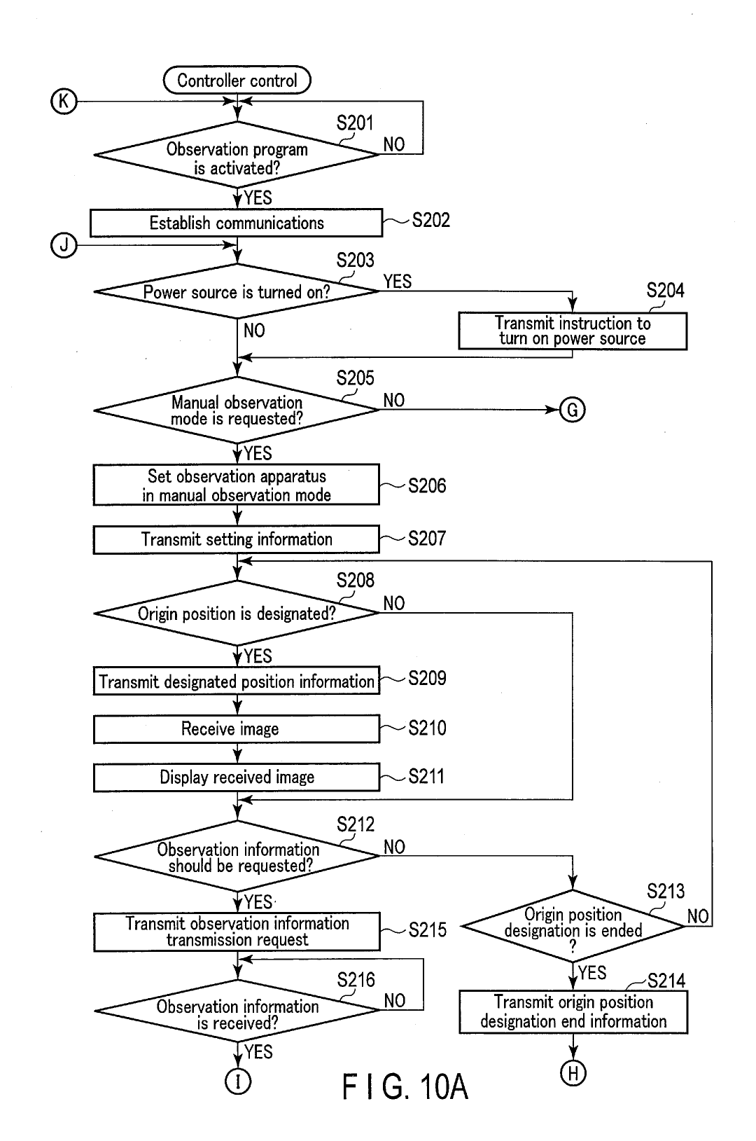

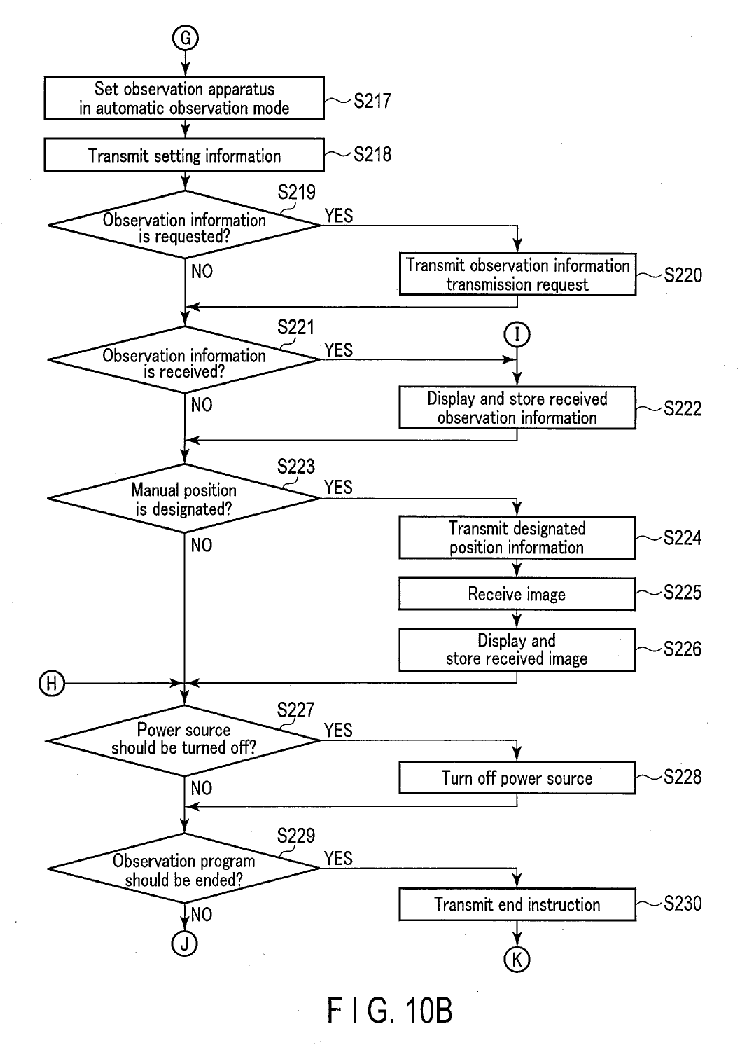

An operation of the controller 200 will be described with reference to the flowchart shown in FIGS. 10A and 10B. The operation shown in the flowchart start when the sample 300 is placed in the observation apparatus 100 and the observation apparatus 100 is held in the incubator.

In step S201, the controller control circuit 230 determines whether an observation program according to the present embodiment is activated. Unless the observation program is activated, the circuit 230 repeats the process of step S201. The controller 200 is not limited to the functions of the controller of the observation system of the present embodiment but may have various functions. Therefore, when the observation program is not activated, the controller 200 may operate as a system other than the observation system 1. If the circuit 230 determines that the observation program is activated, it advances the process to step S202.

In step S202, the controller control circuit 230 establishes communications with the observation apparatus 100. This operation is related to step S103 of the observation apparatus control performed by the observation apparatus 100. That is, the observation apparatus 100 and the controller 200 operate such that the communications between them are established. The communications established then may be low-power-consumption communications being irrelevant to step S103 of the observation apparatus control and only enabling the transmission of an instruction to turn on the observation apparatus 100.

In step S203, the controller control circuit 230 determines whether the user is requesting that the observation apparatus 100 be turned on. For example, when an instruction to turn on the observation apparatus 100 is supplied through the input device 212 by, e.g. a user's touch to an operation button displayed on the operation button display section 216 of the controller 200, the circuit 230 determines that the user is requesting that the power source be turned on. When the circuit 230 determines that the user is not requesting that the power source be turned on, it advances the process to step S205. The time when the user is not requesting that the power source be turned on includes a case where the power source has been turned on. When the circuit 230 determines that the user is requesting that the power source be turned on, it advances the process to step S204.

In step S204, the controller control circuit 230 transmits an instruction to turn on the observation apparatus 100 to the observation apparatus 100. Subsequently, the circuit 230 advances the process to step S205. The operation of step S204 is related to step S101 of the observation apparatus control performed by the observation apparatus 100. Upon receipt of the instruction to turn on the observation apparatus 100 from the controller 200, the observation apparatus 100 is turned on in step S102. The communication means used in the embodiment are low-power-consumption communications such as Bluetooth Low Energy.

In step S205, the controller control circuit 230 determines whether a manual observation mode is requested as the observation mode in the observation apparatus 100. For example, when an instruction to set the observation apparatus 100 in the manual observation mode is supplied through the input device 212 by, e.g. a user's touch to an operation button displayed on the operation button display section 216 of the controller 200, the circuit 230 determines that the manual observation mode is requested. When the circuit 230 determines that the manual observation mode is not requested, or when it determines that an instruction to set the apparatus in the automatic observation mode is supplied through the input device 212, it advances the process to step S217. When the circuit 230 determines that the manual observation mode is requested, it advances the process to step S206.

In step S206, the controller control circuit 230 sets the apparatus in the manual observation mode as the observation mode. Then, the circuit 230 advances the process to step S207.

In step S207, the controller control circuit 230 transmits the setting information to the observation apparatus 100. Then, the circuit 230 advances the process to step S208. The operation of step S207 is related to step S104 of the observation apparatus control performed by the observation apparatus 100. Upon receipt of the setting information from the controller 200, the observation apparatus 100 sets each section in accordance with the setting information through the process of step S105. The setting information includes an observation mode including information for setting the observation apparatus 100 in the manual observation mode. The setting information also includes: information such as observation conditions including a depth of the culture medium 302 of the sample 300, imaging conditions, imaging intervals, information for specifying a movement pattern, and the other parameters; a method for recording observation results; and condition information such as transmission conditions for the observation results. These items of setting information are stored in advance in the controller storage circuit 240 and can be selected by the user through the input device 212. Alternatively, they can be set arbitrarily by the user. Since the observation apparatus 100 is set in the manual observation mode in accordance with the setting information, the observation apparatus 100 determines that the apparatus is set in the manual observation mode through the process of step S106 and performs the process from step S107.

In step S208, the controller control circuit 230 determines whether the user is requesting that the manual designation of the origin position should be transmitted to the observation apparatus 100. For example, when the circuit 230 receives a signal of a touch to the cross-direction button 216B of the operation button display section 216 from the input device 212, it determines that the user is requesting that the manual designation of the origin position should be transmitted. When the circuit 230 determines that the user does not request it, it advances the process to step S213. When the circuit 230 determines that the user is requesting it, it advances the process to step S209.

In step S209, the controller control circuit 230 transmits designated position information to the observation apparatus 100 to move the imaging unit 110 in a direction input by the input device 212. Then, the circuit 230 advances the process to step S210. The operation of step S209 is related to step S107 of the observation apparatus control performed by the observation apparatus 100. In accordance with the designated position information transmitted to the observation apparatus 100 from the controller 200, position adjustment is made through the process of step S109. An image in that position is acquired by the process of step S110 and transmitted by the process of step S112.

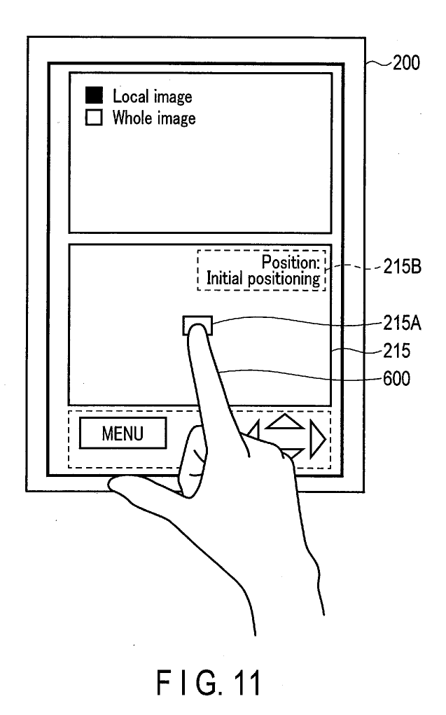

To designate the origin position by the input device 212, various position designation methods can be considered in addition to the foregoing method in which the imaging unit 110 is moved to a desired origin position by repeating a touch to the cross-direction button 216B of the operation button display section 216. For example, as shown in FIG. 11, the user may designate a desired origin position directly by touching a portion corresponding to the desired origin position with his or her finger 600 on the imaging position display section 215 of the display device 211. In accordance with the direct designation of the origin position, the position index 215A is moved and displayed in the position of the touch and the character information 215B indicative of the designation of the origin position is displayed.

In step S210, the controller control circuit 230 receives an image from the observation apparatus 100. Then, the circuit 230 advances the process to step S211. The operation of step S210 is related to step S112 of the observation apparatus control performed by the observation apparatus 100. The circuit 230 receives the corrected image which was transmitted to the controller 200 from the observation apparatus 100.

In step S211, the controller control circuit 230 displays the received image on the taken image display section 214 of the display device 211. Then, the circuit 230 advances the process to step S212. The user can confirm the displayed image to determine whether the current position of the imaging unit 110 of the observation apparatus 100 can be determined as the origin.

In step S212, the controller control circuit 230 determines whether the user is requesting that information be acquired from the observation apparatus 100. For example, when the circuit 230 receives an instruction about information request through the input device 212, it determines that the user is requesting information. Information to be requested is, for example, observation information about the sample 300 obtained by the observation apparatus 100. The observation information may be included in the observation results 500 that have been described with reference to FIG. 9, such as image data on the sample 300. When the circuit 230 determines that the user is requesting information, it advances the process to step S215. When the circuit 230 determines that the user is not requesting information, it advances the process to step S213.

In step S213, the controller control circuit 230 determines whether the origin position designation is ended. For example, when the circuit 230 receives a signal of a touch to the operation button displayed on the operation button display section 216 of the display device 211, it determines that the origin position designation is ended. When the circuit 230 determines that the origin position designation is not ended, it returns the process to step S208. When the circuit 230 determines that the origin position designation is ended, it advances the process to step S214.

In step S214, the controller control circuit 230 transmits origin position designation end information to the observation apparatus 100. Then, the circuit 230 advances the process to step S227. The operation of step S214 is related to step S114 of the observation apparatus control performed by the observation apparatus 100. Upon receipt of the origin position designation end information from the controller 200, the observation apparatus 100 advances the process to step S115 by the determination in step S114.

When the controller control circuit 230 determines in step S212 that the user is requesting that information be acquired from the observation apparatus 100, it transmits an observation information transmission request, which is an instruction to transmit information requested by the user, to the observation apparatus 100 in step S215. After that, the circuit 230 advances the process to step S216. The operation of step S215 is related to step S113 of the observation apparatus control performed by the observation apparatus 100. Upon receipt of the observation information transmission request from the controller 200, the observation apparatus 100 performs an observation process with correction in step S117 as described above.

In step S216, the controller control circuit 230 stands by to receive observation information, such as the first data 501₁ transmitted from the observation apparatus 100. Upon receiving the observation information, the circuit 230 advances the process to step S222. The operation of step S216 is related to step S122 of the observation apparatus control performed by the observation apparatus 100. Since it takes time to perform the observation process with correction in step S117, the circuit 230 stands by until it receives an observation result from the observation apparatus 100.

When the controller control circuit 230 determines in step S205 that the manual observation mode is not requested as the observation mode of the observation apparatus 100, namely when it determines that an instruction to set the observation apparatus 100 in the automatic observation mode is input through the input device 212, the circuit 230 sets the observation apparatus 100 in the automatic observation mode in step S217. Then, the circuit 230 advances the process to step S218.

In step S218, the controller control circuit 230 transmits the setting information to the observation apparatus 100. After that, the circuit 230 advances the process to step S219. The operation of step S218 is related to step S104 of the observation apparatus control performed by the observation apparatus 100. Upon receipt of the setting information from the controller 200, the observation apparatus 100 sets each section in accordance with the setting information through the process of step S105. The setting information includes an observation mode including information for setting the observation apparatus 100 in the automatic observation mode. Since the observation apparatus 100 is set in the automatic observation mode in accordance with the setting information, the circuit 230 determines that the observation apparatus 100 is not set in the manual observation mode through the process of step S106 and performs the process from step S118.

In step S219, the controller control circuit 230 determines whether the user is requesting that information be acquired from the observation apparatus 100. For example, when the circuit 230 receives an instruction about information request through the input device 212, it determines that the user is requesting information. Information to be requested is, for example, observation information about the sample 300 obtained by the observation apparatus 100. The observation information may be included in the observation results 500 that have been described with reference to FIG. 9, such as image data on the sample 300. When the circuit 230 determines that the user is not requesting information, it advances the process to step S221. When the circuit 230 determines that the user is requesting information, it advances the process to step S220.

In step S220, the controller control circuit 230 transmits an observation information transmission request, which is an instruction to transmit information requested by the user, to the observation apparatus 100. Then, the circuit 230 advances the process to step S221. The operation of step S220 is related to step S121 of the observation apparatus control performed by the observation apparatus 100. Upon receipt of the observation information transmission request from the controller 200, the observation apparatus 100 transmits the observation information obtained by the observation process with correction in step S120 through the process of step S122.

In step S221, the controller control circuit 230 determines whether it receives the observation information, such as the second data 501₂ transmitted from the observation apparatus 100. When the circuit 230 determines that it does not receive the observation information, it advances the process to step S223. When the circuit 230 determines that it receives the observation information, it advances the process to step S222. The operation of step S221 is related to step S122 of the observation apparatus control performed by the observation apparatus 100 and is performed to determine whether an observation result is transmitted from the observation apparatus 100.

In step S222, the controller control circuit 230 displays the received observation information on the display device 211 and stores it in the controller storage circuit 240. Then, the circuit 230 advances the process to step S223.

In step S223, the controller control circuit 230 determines whether an instruction about manual position designation is input through the input device 212. There is a case where the user confirms the observation information displayed in step S222 and thus wishes to observe a specific position of the sample 300 again. In this case, a manual position can be designated by a user's instruction using the input device 212, such as an operation of touching a portion corresponding to a specific position of the imaging position display section 215. When the circuit 230 determines that a manual position is not designated, it advances the process to step S227. When the circuit 230 determines that a manual position is designated, it advances the process to step S224.

In step S224, the controller control circuit 230 transmits designated position information to the observation apparatus 100 to move the imaging unit 110 in a direction input by the input device 212. Then, the circuit 230 advances the process to step S225. The operation of step S224 is related to step S123 of the observation apparatus control performed by the observation apparatus 100. In accordance with the designated position information transmitted to the observation apparatus 100 from the controller 200, position adjustment is made through the process of step S124. An image in that position is acquired by the process of step S125 and transmitted by the process of step S127.

In step S225, the controller control circuit 230 receives the image from the observation apparatus 100. Then, the circuit 230 advances the process to step S226. The operation of step S225 is related to step S127 of the observation apparatus control performed by the observation apparatus 100. The circuit 230 receives the corrected image which was transmitted to the controller 200 from the observation apparatus 100.

In step S226, the controller control circuit 230 displays the received image on the taken image display section 214 and stores it in the controller storage circuit 240. Then, the circuit 230 advances the process to step S227.

In step S227, the controller control circuit 230 determines whether the user is requesting that the observation apparatus 100 should be turned off. For example, upon receipt of an instruction to turn off the power source of the observation apparatus 100, the circuit 230 determines that the user is requesting that the power source should be turned off. When the circuit 230 determines that the user is not requesting that the power source should be turned off, it advances the process to step S229. When the circuit 230 determines that the user is requesting that the power source should be turned off, it advances the process to step S228.

In step S228, the controller control circuit 230 transmits an instruction to turn off the power source of the observation apparatus 100 to the observation apparatus 100. Then, the circuit 230 advances the process to step S229. The operation of step S228 is related to step S129 of the observation apparatus control performed by the observation apparatus 100. In accordance with the instruction to turn off the power source of the observation apparatus 100, which is transmitted to the observation apparatus 100 from the controller 200, the power source is turned off through the process of step S130.

In step S229, the controller control circuit 230 determines whether the observation program should be ended. For example, in a situation where the observation apparatus 100 is taken out of the incubator, an instruction to end the observation program is input through the input device 212. When the circuit 230 determines that the observation program should not be ended, it returns the process to step S203. In other words, the foregoing operation is repeated. When the circuit 230 determines that the observation program should be ended, it advances the process to step S230.

In step S230, the controller control circuit 230 transmits to the observation apparatus 100 an instruction to end the observation apparatus control process in the observation apparatus 100. After that, the circuit 230 returns the process to step S201. The operation of step S230 is related to step S128 of the observation apparatus control performed by the observation apparatus 100. In accordance with the instruction to end the observation apparatus control process transmitted to the observation apparatus 100 from the controller, the observation apparatus 100 determines that the observation apparatus control process should be ended through the process of step S128. Thus, the observation apparatus control process is ended.

As described above, the observation in the observation system 1 can be repeated under preset conditions with preset timing from the origin position designated by the user. The observation timing and conditions are input by the user using the controller 200 and set in the observation apparatus 100. Furthermore, the observation in the observation system 1 may be made manually each time the user instructs the observation apparatus 100 using the controller 200.

(Advantage of Observation System)

The observation system 1 of the present embodiment can take an image of cells in the state where the sample 300 is kept stationary in the incubator. It should be noted that an image can be repeatedly taken with time. Since the origin position in which an observation is started is determined, images taken at different times can be compared with one another, with attention focused on the same portion. As a result, how the same cell or cell group changes with time can be observed by comparing the images. Even if the sample 300 is shifted in position as a result of the replacement of a culture medium, the user can designate the same origin position with the last observation timing. In the case of adhesive cells, therefore, how the same cell or cell group changes with time can be observed by comparing the images. The user can thus observe how the same cell or cell group changes with time and analyze the change.

The user can designate the origin position by a simple operation while watching the emitting position or irradiation position of illumination light and the taken image. The origin position can thus be determined in a short time. Therefore, no structural elements other than the imaging unit 110 and the illumination unit originally included in the observation apparatus 100 are necessary for determination of the origin position. The observation apparatus 100 can thus be simplified.

Furthermore, while the imaging unit 110 is moving to the origin position and while it is observing an object, it corrects an image of the object in its moving direction. It is thus possible to obtain an observation result in which the influence of a backlash of the X feed screw 131 and Y feed screw 133 is removed, namely the movement error Δx is corrected.

### Second Embodiment

The second embodiment of the present invention will be described. In the description below, reference will be made to how the second embodiment differs from the first embodiment. Therefore, the same symbols will be used to denote structural elements similar or corresponding to those of the first embodiment, and a description of such structural elements will be omitted. In the observation system 1 of the first embodiment, the feed screws are used as the driving mechanism 130 to move the imaging unit 110. In the second embodiment, a belt is used to move the imaging unit 110. The descriptions of the first embodiment can be applied to the second embodiment unless they are inconsistent with the descriptions of the second embodiment. The devices of the first embodiment can be incorporated into the second embodiment.

(Configuration of Observation System)

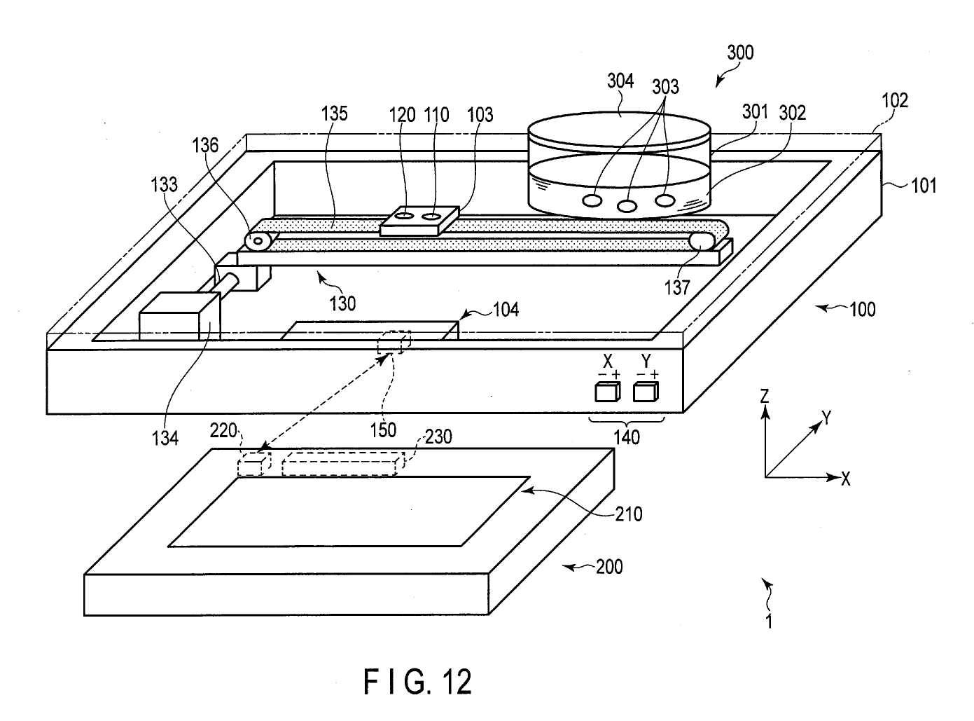

FIG. 12 schematically shows a configuration of an observation system 1 according to the second embodiment. In the second embodiment, a support member 103 on which an imaging unit 110 and an illumination unit 120 are fixed, is attached to an X feed belt 135, as shown in FIG. 12. The X feed belt 135 is wound on a drive roller 136 rotated by an X drive motor and a driven roller 137 provided in the C-axis direction with reference to the drive roller 136. The X feed belt 135 is reciprocated in the X-axis direction by the rotation of the drive roller 136. Accordingly, the imaging unit 110 fixed on the support member 103 attached to the X feed belt 135 can be moved to a desired position in the X-axis direction in accordance with a rotation direction and a rotation amount of the drive roller 136. For the sake of brevity, FIG. 12 does not show the X drive motor, rail guide, or the like.

The feed screw of the first embodiment has the problem of the influence of a backlash upon the movement of the imaging unit 110. The belt used in the second embodiment causes the problem of the influence of extension of the belt upon the movement of the imaging unit 110.

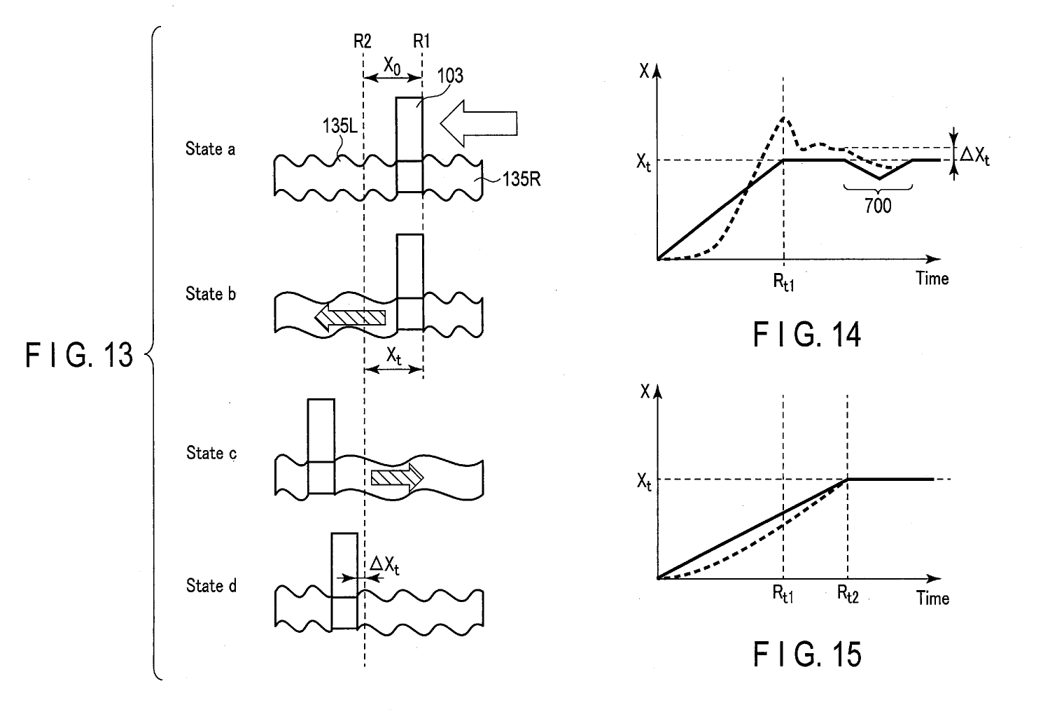

For example, as shown as state a in FIG. 13, assume that the X feed belt 135 is moved by movement amount Xₜ in the left direction as indicated by the arrow in the figure when the support member 103 is in a stationary state. In this case, the drive roller 136 is rotated to roll up a left-side belt 135L of the X feed belt 135, which is on the left side of the support member 103 and feed a right-side belt 135R of the X feed belt 135, which is on the right side of the support member 103. At the initial stage of driving of the drive roller 136, as shown as state b in FIG. 13, the left-side belt 135L is simply pulled and extended by the drive roller 136, and the support member 103 does not move immediately. As the drive roller 136 rotates further, the support member 103 moves abruptly to cancel the extension of the left-side belt 135L.

Assume then that the drive roller 136 is stopped by the rotation amount corresponding to the movement amount Xₜ. Even though the drive roller 136 is stopped, the support member 103 cannot be stopped immediately by the movement amount Xₜ due to an inertial force of the abrupt movement of the support member 103, but moves further in the left direction in FIG. 13, as shown as state c in the figure. Then, the right-side belt 135R is pulled and extended by the support member 103. Thus, the support member 103 is pulled in the direction in which the extension of the right-side belt 135R is canceled, and the support member 103 is pulled back in the right direction in FIG. 13. As a result, the support member 103 (or the imaging unit 110 fixed on the support member 103) is stopped in a position corresponding to a movement amount that is ΔXₜ larger than a desired movement amount Xₜ, as shown as state d in FIG. 13.

In the second embodiment, therefore, auxiliary driving 700 as shown in FIG. 14 is performed to eliminate the influence of extension of the belt when the drive roller 136 is driven or to correct the movement error ΔXₜ. In FIG. 14, the solid line indicates an ideal movement amount in which the driving amount of the drive controller 136 is replaced with the movement amount of the imaging unit 110 and the broken line indicates the actual movement amount of the imaging unit 110. When the drive roller 136 is driven only for time Rₜ₁ to move the support member 103 by movement amount Xₜ, a movement error ΔXₜ is caused from Xₜ as shown as state d in FIG. 13. Performing auxiliary driving 700 of moving the X feed belt 135 backward or rotating the drive roller 136 backward and then forward every predetermined time interval, the imaging unit 110 can be moved to a target position. In the auxiliary driving 700, the drive roller 136 is driven at low speed to prevent the X feed belt 135 from extending and allow the imaging unit 110 to be positioned correctly.

The extension of the X feed belt 135 is the problem caused when the drive roller 136 is driven at high speed. When the imaging unit 110 is moved to the origin of observation, the drive roller 136 should be driven at high speed such that the imaging unit 110 can move a long distance in a short time. In other words, it is when correct positioning is required that the X feed belt 135 is extended.

In the actual observation, the movement distance is very short and thus the drive roller 136 need not be driven at so high speed. As shown in FIG. 15, when the drive roller 136 is drive at low speed, or when it is driven for time Rₜ₂ that is longer than time Rₜ₁ to move by the movement amount Xₜ, no movement error is caused. Hereinafter, the low-speed driving will be referred to as response wait type driving.

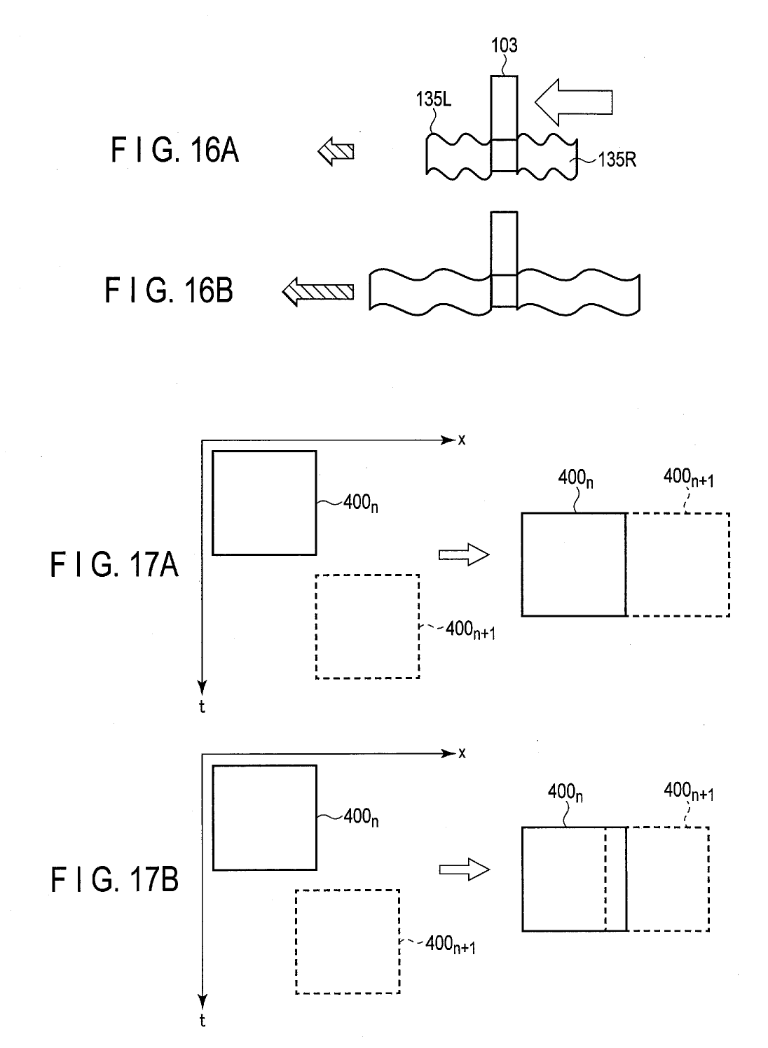

The X feed belt 135 not only extends dynamically when the drive roller 136 is driven at high speed as described above, but also extends statically irrespective of the driving state. In other words, it is considered that the X feed belt 135 extends due to a change in temperature and with time. When the X feed belt 135 is not extended as shown in FIG. 16A, the driving amount of the drive roller 136 necessary to move the support member 103 by a given amount in the left direction in the figure is considered to be an amount as represented by the hatched arrow in the figure. As shown in FIG. 16B, the static extension of the X feed belt 135 is caused on both the left-side belt 135L and right-side belt 135R and requires a larger driving amount as represented by the hatched arrow in the figure.

In the second embodiment, therefore, the relationship between the current rotation amount and movement pitch of the drive roller 136 is detected when the observation is started from the origin position with each observation timing in order to correct a movement error due to a static extension of the X feed belt 135. This relationship can be obtained by driving the drive roller 136 by a very small amount and comparing local images acquired by the imaging unit 110. For example, when the X feed belt 135 is not extended as shown in FIG. 16A, the drive roller 136 is controlled such that for example, adjacent two local images 400ₙ and 400ₙ₊₁ in the X direction can be acquired as shown in FIG. 17A. When the drive roller 136 is so driven, if the X feed belt 135 is extended as shown in FIG. 16B, the acquired two local images 400ₙ and 400ₙ₊₁ will overlap each other as shown in FIG. 17B. If, therefore, the rotation amount is increased to prevent the local images from overlapping, the influence of the extension of the X feed belt 135 can be eliminated, and each of the local images 400 can be acquired in the same position with each observation timing.

(Operation of Observation System)

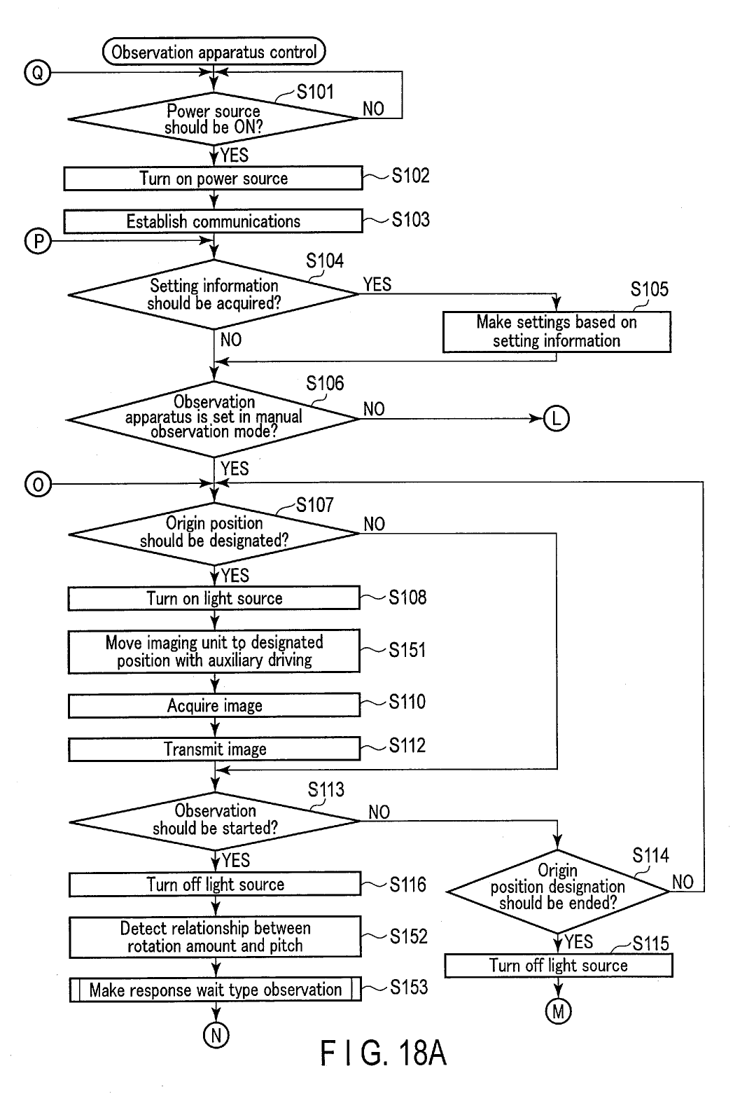

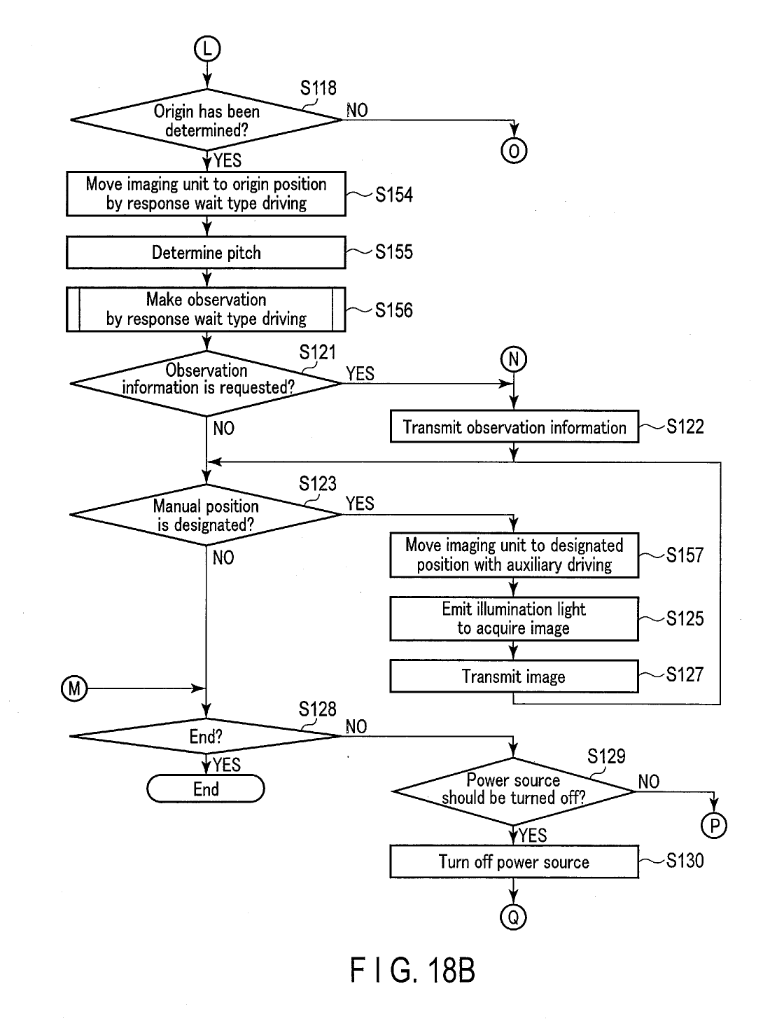

The operation of an observation apparatus 100 in the observation system 1 according to the second embodiment will be described below with reference to the flowchart shown in FIGS. 18A and 18B. The operation of the flowchart starts when a sample 300 is set in the observation apparatus 100 and then the observation apparatus 100 is held in the incubator. The flowchart corresponds to time lapse imaging, such as repeating an observation at predetermined times.

Steps S101 to S108 in the flowchart are described in the foregoing first embodiment.

In the second embodiment, an observation apparatus control circuit 160 activates a driving mechanism 130 to move the imaging unit 110 to the designated position with auxiliary driving 700 in step S151 in place of step S109 of the first embodiment. Then, the observation apparatus control circuit 160 advances the process to step S110.

Steps S110 to S115 in the flowchart are described in the foregoing first embodiment. In the second embodiment, however, the imaging unit 110 can be moved correctly to the designated position because it is moved with auxiliary driving 700 in step S151. It is thus unnecessary to correct the imaging position information of the acquired image based on the movement direction as in step S111 of the first embodiment. The process of step S111 is thus omitted.

Steps S107 to S114 described above are repeated. Accordingly, the origin of observation can be designated correctly by auxiliary driving 700 to correct a movement error of the imaging unit 110, caused by the extension of the X feed belt 135 due to high-speed driving of the drive roller 136 in step S151 while the imaging unit 110 is moving to the origin of observation.

If the origin of observation is so determined, the observation apparatus control circuit 160 receives an observation information transmission request from a controller 200 and thus determines in step S113 that an observation start is designated. The circuit 160 advances the process to step S116.

Step S116 is as described in the first embodiment.

After that, in the second embodiment, the operations of steps S152 and S153 are performed in place of the operation of step S117 in the first embodiment.

In step S152, the observation apparatus control circuit 160 instructs the driving mechanism 130 to drive the drive roller by a very small amount as described above, and compares local images acquired by the imaging unit 110 before and after the driving to detect the relationship between the rotation amount and movement pitch of the drive roller 136. Then, the circuit 160 advances the process to step S153.

In step S153, the observation apparatus control circuit 160 performs a response wait type observation process. More specifically, first, the circuit 160 instructs the driving mechanism 130 to return the imaging unit 110, which was moved for the above detection in step S152, to the origin position by the response wait type driving. Then, the circuit 160 turns on a light source 122 of the illumination unit 120 to emit illumination light for observation, and instructs the driving mechanism 130 to cause the imaging unit 110 to take images repeatedly while changing the position of the imaging unit 110 according to a specific rule by the response wait type driving. In this case, the rotation amount of the drive roller 136 for moving the imaging unit 110 to a desired position is controlled based on the relationship detected in step S152 so as to remove the influence due to a static extension of the X feed belt 135, which is caused by temperature or a lapse of time as described above, namely to correct a static movement error. The circuit 160 performs a given process for the acquired image and stores a result of the observation in an observation apparatus storage circuit 170. Upon completion of the observation, the circuit 160 turns off the light source 122 of the illumination unit 120 to stop emitting illumination light for observation. After that, the circuit 160 advances the process to step S122.

When the observation apparatus control circuit 160 determines in step S106 that the observation apparatus 100 is not set in the manual observation mode, or it is set in the automatic observation mode, the circuit 160 advances the process to step S118. Step S118 is as described in the foregoing first embodiment. When the circuit 160 determines in step S118 that the origin of observation has already determined, it advances the process to step S154 in place of step S119 of the first embodiment.

In step S154, the observation apparatus control circuit 160 activates the driving mechanism 130 to move the imaging unit 110 to the origin position. In the automatic observation mode, at least one observation has already been made, and the imaging unit 110 is not so distant from the origin position. The imaging unit 110 is thus moved to the origin position by the response wait type driving to rotate the drive roller 136 at low speed. To start the observation quickly, the imaging unit 110 can be moved by not the response wait type driving but with the auxiliary driving 700. Then, the circuit 160 advances the process to step S155.

In step S155, the observation apparatus control circuit 160 determines a pitch. This operation is to detect the relationship between the rotation amount and movement pitch of the drive roller 136 by instructing the driving mechanism 130 to drive the drive roller 136 by a very small amount and comparing local images acquired by the imaging unit 110 before and after the driving, as in step S152. Then, the circuit 160 advances the process to step S156.

In step S156, the observation apparatus control circuit 160 performs a response wait type observation process as in step S153. More specifically, the circuit 160 first instructs the driving mechanism 130 to return the imaging unit 110, which was moved for the pitch determination in step S155, to the origin position by the response wait type driving. Then, the circuit 160 turns on the light source 122 of the illumination unit 120 to emit illumination light for observation, and instructs the driving mechanism 130 to cause the imaging unit 110 to take images repeatedly while changing the position of the imaging unit 110 according to a specific rule by the response wait type driving. In this case, the rotation amount of the drive roller 136 for moving the imaging unit 110 to a desired position is controlled based on the relationship detected in step S155 so as to remove the influence due to a static extension of the X feed belt 135, which is caused by temperature or a lapse of time as described above, namely to correct a static movement error. The circuit 160 performs a given process for the acquired image and stores a result of the observation in the observation apparatus storage circuit 170. Upon completion of the observation, the circuit 160 turns off the light source 122 of the illumination unit 120 to stop emitting illumination light for observation. After that, the circuit 160 advances the process to step S121.

Steps S121 to S123 are as described in the foregoing first embodiment. When the observation apparatus control circuit 160 determines in step S123 that a manual position is designated by the controller 200, it advances the process to step S157 in place of step S124 of the first embodiment.

In step S157, the observation apparatus control circuit 160 activates the driving mechanism 130 to move the imaging unit 110 to a manually designated position with the auxiliary driving 700. Since the designated position corresponds to somewhere in the sample 300, it is not so distant from the position of the imaging unit 110 at the end of the observation. The imaging unit 110 can thus be moved with not the auxiliary driving 700 but the response wait type driving. Then, the circuit 160 advances the process to step S125.

Steps S125 to S130 are as described in the foregoing first embodiment. In the second embodiment, however, the imaging unit 110 can be moved correctly to the designated position because it is moved with the auxiliary driving 700 in step S157. It is thus unnecessary to correct the imaging position information of the acquired image based on the movement direction as in step S126 of the first embodiment. The process of step S126 is thus omitted.

As has been described, the observation apparatus 100 repeats the observation in the second embodiment as well.

(Feature of Observation System)

The same advantages as described above in relation to the observation system 1 of the first embodiment can be obtained by the observation system 1 of the second embodiment as well.

In the second embodiment, the X feed belt 135 is used in place of the X feed screw 131 of the first embodiment. Since a dynamic movement error of the imaging unit 110 due to the extension of the X feed belt 135 at the time of high-speed driving is corrected by the auxiliary driving 700, the imaging unit 110 can be moved correctly to the origin position. Since, furthermore, the rotation amount of the drive roller 136 is controlled so as to detect the relationship between the rotation amount and movement pitch of the drive roller 136 and correct a static movement error due to an extension of the X feed belt 135, which is caused by a change in temperature or a lapse of time, each of the local images 400 can be acquired in the same position with each observation timing.

Of the techniques described in connection with the above embodiments, the controls described with reference to the flowcharts are achieved as programs. The programs can be stored in a recording medium or a storage unit. The programs can be recorded in the recording medium or storage unit in various ways. They may be recorded at the time of shipping a product, they can be recorded using a distributed recording medium, or they can be downloaded from the Internet.

In each of the foregoing embodiments, the top of the casing 101 of the observation apparatus 100 is covered with the transparent plate 102, and the sample 300 is placed on the top of the casing 101. However, the present invention is not limited to this. The shape of the observation apparatus 100 can be modified appropriately in accordance with the shape of the sample 300, a desired observation direction, or the like.

In each of the foregoing embodiments, the observation apparatus 100 is simply designed to take images of a cell and the like, which are being cultured, and which records the taken images. The observation apparatus 100 may conduct different analyses, based upon the acquired image, using the observation apparatus control circuit 160 or the image processing circuit 180. For example, the observation apparatus control circuit 160 or the image processing circuit 180 may extract images of a cell or a cell group included in the sample 300 based upon the acquired image, and calculates the number of cells or cell groups. The results of the analysis so obtained are stored in the observation apparatus storage circuit 170 or transmitted to the controller 200 through the observation apparatus communication device 150. The observation apparatus 100 can be configured as a measurement apparatus for measurement as well as observation. Alternatively, if the controller 200 is caused to have functions of analyzing an image taken by the observation apparatus 100 of each of the embodiments to acquire the number of cells or cell groups, the form thereof, or the like, and recording the analysis results. Accordingly, a measurement system including the observation apparatus 100 can be configured.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An observation apparatus comprising:
an imaging unit configured to take an image of an object;
a driving mechanism configured to move the imaging unit;
a control circuit configured to control an operation of the driving mechanism and an operation of the imaging unit in association with each other; and
a position designation unit configured to designate a priority observation position in part of the object,
wherein the control circuit moves the imaging unit to the priority observation position on a priority basis when the control circuit controls the operation of the driving mechanism and the operation of the imaging unit in association with each other to observe a predetermined region including the part of the object.

2. The apparatus according to claim 1, further comprising:
an illumination unit configured to emit illumination light for confirming an observation position when the position designation unit designates the priority observation position.

3. The apparatus according to claim 1, wherein
the control circuit controls the operation of the driving mechanism and the operation of the imaging unit in time sequence according to a specific rule in order to observe the predetermined region including the part of the object from the priority observation position.

4. The apparatus according to claim 3, further comprising:
an illumination unit configured to emit illumination light for confirming an observation position when the position designation unit designates the priority observation position.

5. The apparatus according to claim 1, further comprising:
a storage circuit configured to store the priority observation position as a driving mechanism driving amount from an initial position.

6. The apparatus according to claim 5, further comprising:
an illumination unit configured to emit illumination light for confirming an observation position when the position designation unit designates the priority observation position.

7. The apparatus according to claim 1, wherein:
the driving mechanism has a movement error caused when the imaging unit is moved; and
the apparatus further comprising a storage circuit configured to store the movement error of the driving mechanism.

8. The apparatus according to claim 7, further comprising:
an illumination unit configured to emit illumination light for confirming an observation position when the position designation unit designates the priority observation position.

9. The apparatus according to claim 3, wherein:
the driving mechanism has a movement error caused when the imaging unit is moved; and
the control circuit controls the driving mechanism to move the imaging unit while correcting the movement error when the imaging unit is moved from the priority observation position according to the specific rule.

10. The apparatus according to claim 9, wherein:
the driving mechanism includes a feed screw;
the movement error is determined by a relationship between a position of the feed screw with reference to a thread of the feed screw and a rotation direction of the feed screw when the imaging unit starts to move; and
the control circuit controls the driving mechanism to correct the movement error when the imaging unit is moved from the priority observation position according to the specific rule and a movement direction thereof is reversed.

11. The apparatus according to claim 9, wherein:
the driving mechanism includes a feed belt driven by a drive roller;
the movement error is determined by a relationship between a movement amount of the feed belt and a rotation amount of the drive roller, which vary with an amount of extension of the feed belt; and
the control circuit acquires the relationship between a movement amount of the feed belt and a rotation amount of the drive roller when the imaging unit is moved from the priority observation position according to the specific rule, and controls the driving mechanism to correct the movement error based on the acquired relationship.

12. The apparatus according to claim 11, wherein:
the movement error is further determined by an extension of the feed belt caused when the imaging unit is moved at high speed; and
the control circuit controls the driving mechanism to perform auxiliary driving of rotating the drive roller in forward direction and then backward direction in order to correct the movement error when the imaging unit is moved at high speed.

13. An observation method in which an operation of an imaging unit configured to take an image of an object and an operation of a driving mechanism configured to move the imaging unit are controlled in association with each other, the method comprising:
designating a priority observation position in part of the object; and
moving the imaging unit to the priority observation position on a priority basis when the operation of the driving mechanism and the operation of the imaging unit are controlled in association with each other to observe a predetermined region including the part of the object.

14. An observation system comprising:
the observation apparatus according to claim 1, wherein the apparatus further comprises a communication device; and
a controller configured to communicate with the observation apparatus through the communication device and control an operation of the observation apparatus.
